(19) United States
(12) Patent Application Publication
(10) Pub. No.: US 2023/0131680 A1
(43) Pub. Date: Apr. 27, 2023

(54) PROCESS AND CATALYST

(71) Applicant: Oxford University Innovation Limited, Oxford (GB)

(72) Inventors: Tiancun XIAO, Oxford (GB); Weisong Li, Oxford (GB); Peter Edwards, Oxford (GB); Xiangyu Jie, Oxford (GB)

(21) Appl. No.: 17/919,907

(22) PCT Filed: Apr. 19, 2021
(86) PCT No.: PCT/GB2021/050937

§ 371 Date: Oct. 19, 2022

(30) Foreign Application Priority Data
Apr. 20, 2020 (GB) 2005728.7

(51) Int. Cl. C01B 3/40; B01J 23/755

(52) U.S. Cl. CPC C01B 3/40; B01J 23/755; C01B 2203/1082; C01B 2203/0855; C01B 2203/86

(57) ABSTRACT

A process for producing a gaseous product comprising hydrogen, said process comprising exposing a gaseous hydrocarbon to microwave radiation in the presence of a solid catalyst, wherein the catalyst comprises at least one metal species on a support, wherein the metal species is at least one a nickel species or a cobalt species; and a solid catalyst suitable for use in said process, and wherein the support comprises at least one of a carbonate or an alkaline earth metal oxide.

### INTRODUCTION

The present invention relates to a process for producing a gaseous product comprising hydrogen from gaseous hydrocarbons. In particular, the process of the present invention provides a process that can provide capture, storage and utilisation of carbon dioxide in a cyclic process. Furthermore, the present invention provides a solid catalyst for use in the process of the invention which acts as both a source of carbon dioxide and as a carbon capture precursor.

### BACKGROUND OF THE INVENTION

To limit global warming well below 2° C., as pledged in Paris Agreement, carbon capture and storage (CCS), renewable energy development and end-use energy efficiency improvement are projected to contribute about 82% of cumulative reductions in CO₂ emissions by 2050.11 Among these strategies, CCS is a low-carbon option applicable to the large scale stationary CO₂ sources such as coal-fired power plants and energy-intensive industrial sectors. However, the economic potential of the CCS processes may be unrealised by simply storing CO₂ geologically as waste. Furthermore, the potential ecological hazards associated with CO₂ sequestration are still uncertain.^{[2]}

Recently, CO₂ has been recognized as a suitable carbon source and, once activated for chemical conversion and production, may improve the economic competitiveness of CCS plants and offer a pathway to close the carbon cycle within the human socioeconomic system.

Currently, only 0.3% of the global CO₂ emissions have been converted into chemicals, and more than 90% of that has been used for producing urea which results in ultimately releasing CO₂ back into the atmosphere when it is used as fertilizer. There are numerous laboratory approaches, such as electrochemical and photocatalytic reduction of CO₂, to produce useful organic products including alcohols, alkanes, olefins and fuels from CO₂, but processes capable of consuming and converting large quantities of CO₂ are still lacking.

To date, the methane dry reforming reaction (MDR) which reforms CH₄ with CO₂ into the platform mixture of H₂ and CO₂ seems to be the only approach that is near to industrial application for the utilization of CO₂ on a large scale. However, there are two main challenges for the traditional thermal MDR process: 1) the energy intensive capture and purification processes for supplying CO₂ as feedstock; 2) high operation temperature (820° C., calculated via HSC chemistry)^{[3]} and catalyst deactivation caused by carbon deposition. Thus, it would be attractive to develop a method to capture CO₂ in an easier, energy efficient way and then directly convert the captured CO₂ into useful products in fewer steps.

Recently, the CO₂ capture and its direct activation in one single system were demonstrated over the nickel/calcium-based composite catalysts,^{[1,4]}.

Calcium-based absorbents have been intensively studied for CO₂ capture, and the calcium-looping carbonation and calcination process has been recognized as a promising method for the high temperature CO₂ capture from flue gases. However, the CO₂ uptake capacity of the calcium absorbents normally decreases very quickly after several cycles in these high temperature CO₂ capture processes due to the blockage by CaCO₃ formed on the CaO absorbent surface, which hinders the contact of CO₂ with CaO absorbent. Furthermore, the desorption of CO₂ requires very high temperature, with corresponding large amounts of energy input.

To overcome the rapid CO₂ uptake capacity decrease, many methods including doping and pre-combustion have been used to stabilize the microstructures of the CaO absorbents, or use of water has been adopted to hydrate the CaO to form Ca(OH)₂.^{[5]} In these methods, nearly all of the processes start with CaO as absorbent and calcium salts (calcium nitrate, calcium acetate, etc.) are used as precursors for preparing the CaO absorbents, which is accompanied by huge pollutant emissions (such as nitrogen oxides or CO₂). Considering the high consumption of CaO absorbents with specific nanostructures in large-scale CO₂ processes, it would also be desirable to prepare and use absorbents with adequate CO₂ uptake capacities.

The present invention provides a cyclic process comprising hydrocarbon dry reforming, CO₂ capture and its rapid activation for use in further hydrocarbon reforming. Rapid and selective heating offer the potential of reforming hydrocarbon at relatively low catalyst bed temperatures with carbonate as CO₂ carrier, subsequently allowing for the formation of a CO₂ absorbent without generating much exhaust heat.

Besides the potential for improving the energy efficiency of carbonate decomposition compared with the traditional thermal calcium looping CO₂ capture processes, the lower catalyst bed temperatures minimizes the CO₂ uptake capacity losses of CaO absorbent. A bifunctional catalyst-absorbent system for CO₂ capture and conversion expands future application scenarios to include use in flue gas CO₂ capture in CO₂ intensive industrial sectors, as well as sucking CO₂ directly from atmosphere (which will normally encounter steam and moisture in the CO₂ absorption procedures). The present invention thus assists in combatting global warming.

### SUMMARY OF THE INVENTION

In one aspect, the present invention relates to a process for producing a gaseous product comprising hydrogen, said process comprising exposing a gaseous hydrocarbon to microwave radiation in the presence of a solid catalyst, wherein the catalyst comprises at least one metal species on a support, wherein the metal species is at least one of a nickel species or a cobalt species, and wherein the support comprises at least one of a carbonate or an alkaline earth metal oxide.

In another aspect, the present invention relates to a solid catalyst comprising one or more metal oxides on a support, wherein the metal oxide is at least one of a nickel oxide or a cobalt oxide, and wherein the support comprises at least one of a carbonate or an alkaline earth metal oxide.

In another aspect, the present invention relates to a microwave reactor comprising a heterogeneous mixture, said mixture comprising a solid catalyst as defined herein in admixture with a gaseous hydrocarbon.

In another aspect, the present invention relates to a fuel cell module comprising (i) a fuel cell and (ii) a heterogeneous mixture comprising a solid catalyst as defined herein in admixture with a gaseous hydrocarbon.

Preferred, suitable, and optional features of any one particular aspect of the present invention are also preferred, suitable, and optional features of any other aspect.

### BRIEF DESCRIPTION OF THE DRAWINGS

FIG. 1 shows the system configuration for the microwave-initiated reforming reaction over the metal/carbonate bi-functional catalysts.

FIG. 2 shows the methane reforming results over different metal species supported on CaCO₃ powder including (A) calculated CaCO₃ conversion and the percentage of CO₂ converted into syngas (B) the molar amounts of generated H₂ and CO.

FIG. 3 shows the methane reforming results over the CaCO₃ supported nickel species samples with different Ni/Ca ratios including (A) calculated CaCO₃ conversion and percentage of the CO₂ converted into syngas (B) the molar amounts of generated H₂ and CO.

FIG. 4 shows methane reforming results over the NiO/CaCO₃ (1:18) sample with different CH₄ feed flowrates including (A) calculated CaCO₃ conversion and the percentage of CO₂ converted into syngas (B) the molar amounts of generated H₂ and CO.

FIG. 5 shows time-on-stream results of methane reforming over NiO/CaCO₃ with a Ni/Ca ratio of 1:18 including (A) amounts of the gases generated in each time period; (B) microwave power curves and the IR pyrometer recorded catalyst bed temperature.

FIG. 6 shows the results of each cycle of methane reforming reaction including (A) calculated CaCO₃ and CO₂ conversions; (B) molar amount of generated H₂ and CO.

FIG. 7 shows cyclic methane reforming performances over catalysts (Ni/Ca ratio of 1:18) regenerated by three different carbonate sources (CO₂ (g), Na₂CO₃ and NH₄HCO₃) including (A) calculated conversions of CaCO₃ (solid line) and CO₂ (dashed line); (B) generated H₂ and CO molar amounts.

FIG. 8 shows the morphologies of the catalyst at various stages in the CO₂ capture and methane reforming cycle. (A) to (D) are SEM images. (A) fresh NiO/CaCO₃ sample; (B) NiO/CaCO₃ sample after methane reforming reaction; (C) sample after first regeneration using CO₂ in H₂O medium. (D) sample after the 12th cycle and calcination in 700° C. air to remove deposited carbon; (E) to (H) are the corresponding TEM images of the samples presented in A) to (D), respectively.

### DETAILED DESCRIPTION OF THE INVENTION

### Definitions

As used herein the term “gaseous product” refers to a product which is gaseous at standard ambient temperature and pressure (SATP), i.e. at a temperature of 298.15 K (25° C.) and at 100,000 Pa (1 bar, 14.5 psi, 0.9869 atm).

As used herein the term “gaseous hydrocarbon” refers to a hydrocarbon which is gaseous at standard ambient temperature and pressure (SATP), i.e. at a temperature of 298.15 K (25° C.) and at 100,000 Pa (1 bar, 14.5 psi, 0.9869 atm). Examples include methane, ethane, propane and butane.

As used herein the term “hydrocarbon” refers to organic compounds consisting of carbon and hydrogen.

For the avoidance of doubt, hydrocarbons include straight-chained and branched, saturated and unsaturated aliphatic hydrocarbon compounds, including alkanes, alkenes, and alkynes.

A “Cₙ₋ₘ hydrocarbon” or “Cₙ-Cₘ hydrocarbon” or “Cₙ-Cₘ hydrocarbon”, where n and m are integers, is a hydrocarbon, as defined above, having from n to m carbon atoms. For instance, a C₁₋₄ hydrocarbon is a hydrocarbon as defined above which has from 1 to 4 carbon atoms.

The term “alkane”, as used herein, refers to a linear or branched chain saturated hydrocarbon compound. Examples of alkanes, are for instance, methane, ethane, propane, butane, Alkanes such as dimethylbutane may be one or more of the possible isomers of this compound. Thus, dimethylbutane includes 2,3-dimethybutane and 2,2-dimethylbutane. This also applies for all hydrocarbon compounds referred to herein.

The term “alkene”, as used herein, refers to a linear or branched chain hydrocarbon compound comprising one or more double bonds. Examples of alkenes are ethene, propene, butene, etc. Alkenes typically comprise one or two double bonds. The terms “alkene” and “olefin” may be used interchangeably. The one or more double bonds may be at any position in the hydrocarbon chain. The alkenes may be cis- or trans-alkenes (or as defined using E- and Z-nomenclature). An alkene comprising a terminal double bond may be referred to as an “alk-1-ene” (e.g. hex-1-ene), a “terminal alkene” (or a “terminal olefin”), or an “alphaalkene” (or an “alpha-olefin”).

As used herein “metal species” is any compound comprising a metal. As such, a metal species includes the elemental metal, metal oxides and other compounds comprising a metal, i.e. metal salts, alloys, hydroxides, carbides, borides, silicides and hydrides. When a specific example of a metal species is stated, said term includes all compounds comprising that metal, e.g. nickel species includes elemental nickel, nickel oxides, nickel salts, nickel alloys, nickel hydroxides, nickel carbides, nickel borides, nickel silicides and nickel hydrides for instance.

As used herein, the term “elemental metal” or specific examples such as “elemental Ni”, for example, refers to the metal only when in an oxidation state of zero.

Unless stated to the contrary, reference to elements by use of standard notation refers to said element in any available oxidation state. Similarly, wherein the term “metal” is used without further restriction no limitation to oxidation state is intended other than to those available.

As used herein, the term “transition metal” refers to an element of one of the three series of elements arising from the filling of the 3d, 4d and 5d shells. Unless stated to the contrary, reference to transition metals in general or by use of standard notation of specific transition metals refers to said element in any available oxidation state.

As used herein, the term “alkaline earth metal” refers to an element of group 2 of the periodic table of elements.

As used herein, the term “heterogeneous mixture” refers to the physical combination of at least two different substances wherein the two different substances are not in the same phase at standard ambient temperature and pressure (SATP), i.e. at a temperature of 298.15 K (25° C.) and at 100,000 Pa (1 bar, 14.5 psi, 0.9869 atm). For instance, one substance may be a solid and one substance may be a gas.

As used herein “solid catalyst” refers to the solid material to which the reactants or feed is exposed to in order to effect a catalytic transformation. The solid catalyst is solid at standard ambient temperature and pressure (SATP), i.e. at a temperature of 298.15 K (25° C.) and at 100,000 Pa (1 bar, 14.5 psi, 0.9869 atm). The solid catalyst may or may not require activation (for instance, in a preliminary step or under the reaction conditions) in order to provide the catalytically active species.

As used herein “syngas” (also known as synthesis gas), is a fuel gas mixture essentially consisting of hydrogen and carbon monoxide. However, minor quantities of carbon dioxide and hydrocarbons may be present.

### Process

In one aspect, the present invention relates to a process for producing a gaseous product comprising hydrogen, said process comprising exposing a gaseous hydrocarbon to microwave radiation in the presence of a solid catalyst, wherein the catalyst comprises at least one metal species on a support, wherein the metal species is a nickel species or a cobalt species, and wherein the support comprises at least one of a carbonate or an alkaline earth metal oxide.

In one embodiment, the process produces about 40 vol. % or more of hydrogen in the total amount of gaseous product. Suitably, about 45 vol. % or more of hydrogen in the total amount of gaseous product, more suitably about 50 vol. % or more of hydrogen, more suitably about 55 vol. % or more of hydrogen, more suitably about 60 vol. % or more of hydrogen, more suitably about 65 vol. % or more of hydrogen, more suitably about 70 vol. % or more of hydrogen, more suitably about 75 vol. % or more of hydrogen, or more suitably about 80 vol. % or more of hydrogen in the total amount of gaseous product.

In another embodiment, the process produces about 45 vol. % to about 90 vol. % of hydrogen in the total amount of gaseous product. Suitably, about 45 vol. % to about 85 vol. % of hydrogen in the total amount of gaseous product, more suitably about 45 vol. % to about 80 vol. % of hydrogen, more suitably about 45 vol. % to about 75 vol. % of hydrogen, more suitably about 45 vol. % to about 70 vol. % of hydrogen, more suitably about 45 vol. % to about 65 vol. % of hydrogen, or more suitably about 45 vol. % to about 60 vol. % of hydrogen in the total amount of gaseous product.

In another embodiment, the process produces about 50 vol. % to about 99 vol. % of hydrogen in the total amount of gaseous product. Suitably, about 55 vol. % to about 99 vol. % of hydrogen in the total amount of gaseous product, more suitably about 60 vol. % to about 99 vol. % of hydrogen, more suitably about 65 vol. % to about 99 vol. % of hydrogen, more suitably about 70 vol. % to about 99 vol. % of hydrogen, more suitably about 75 vol. % to about 99 vol. % of hydrogen, or more suitably about 80 vol. % to about 99 vol. % of hydrogen in the total amount of gaseous product.

In one embodiment, the process produces about 25 vol. % or more of carbon monoxide in the total amount of gaseous product. Suitably, about 30 vol. % or more of carbon monoxide in the total amount of gaseous product, more suitably about 35 vol. % or more of carbon monoxide, more suitably about 40 vol. % or more of carbon monoxide, more suitably about 45 vol. % or more of carbon monoxide, more suitably about 50 vol. % or more of carbon monoxide in the total amount of gaseous product.

In one embodiment, the process produces about 10 vol. % to about 60 vol. % of carbon monoxide in the total amount of gaseous product. Suitably, about 45 vol. % to about 85 vol. % of hydrogen in the total amount of gaseous product, more suitably about 45 vol. % to about 80 vol. % of hydrogen, more suitably about 45 vol. % to about 75 vol. % of hydrogen, more suitably about 45 vol. % to about 70 vol. % of hydrogen, more suitably about 45 vol. % to about 65 vol. % of hydrogen, or more suitably about 45 vol. % to about 60 vol. % of hydrogen in the total amount of gaseous product.

In one embodiment, the gaseous product comprises hydrogen and carbon monoxide. In one embodiment, the molar ratio of hydrogen to carbon monoxide in the gaseous product is about 10:1 to about 1:10. In another embodiment, the molar ratio of hydrogen to carbon monoxide in the gaseous product is about 3:1 to about 1:3, suitably about 3:1 to about 1:2, more suitably about 3:1 to about 2:3, more suitably about 3:1 to about 5:6, more suitably about 3:1 to about 10:11.

In another embodiment, the gaseous product comprises hydrogen and carbon monoxide wherein the molar ratio of hydrogen to carbon monoxide in the gaseous product is about 2:1 to about 1:2, more suitably about 2:1 to about 2:3, more suitably about 2:1 to about 5:6, more suitably about 2:1 to about 10:11.

In another embodiment, the gaseous product comprises hydrogen and carbon monoxide wherein the molar ratio of hydrogen to carbon monoxide in the gaseous product is about 3:2 to about 1:2, more suitably about 3:2 to about 2:3, more suitably about 3:2 to about 5:6, more suitably about 3:2 to about 10:11.

In another embodiment, the gaseous product comprises hydrogen and carbon monoxide wherein the molar ratio of hydrogen to carbon monoxide in the gaseous product is about 6:5 to about 5:6, more suitably about 6:5 to about 10:11.

In another embodiment, the gaseous product comprises hydrogen and carbon monoxide wherein the molar ratio of hydrogen to carbon monoxide in the gaseous product is about 1:1 to about 2:1, more suitably about 1:1 to about 3:2, more suitably about 1:1 to about 6:5.

In another embodiment, the gaseous product comprises hydrogen and carbon monoxide wherein the molar ratio of hydrogen to carbon monoxide in the gaseous product is about 1:1.

In one embodiment, the gaseous product comprises about 50 vol. % or more of hydrogen and carbon monoxide in the total amount of gaseous product. In another embodiment, the gaseous product comprises about 70 vol. % or more of hydrogen and carbon monoxide in the total amount of gaseous product. Suitably, about 75 vol. % or more of hydrogen and carbon monoxide in the total amount of gaseous product, more suitably about 80 vol. % or more of hydrogen and carbon monoxide, more suitably about 85 vol. % or more of hydrogen and carbon monoxide, more suitably about 90 vol. % or more of hydrogen and carbon monoxide, more suitably about 95 vol. % or more of hydrogen and carbon monoxide, more suitably about 98 vol. % or more of hydrogen and carbon monoxide, more suitably about 99 vol. % or more of hydrogen and carbon monoxide in the total amount of gaseous product.

In another embodiment, the gaseous product comprises about 10 vol. % to about 100 vol. % of hydrogen and carbon monoxide in the total amount of gaseous product. In another embodiment, the gaseous product comprises about 60 vol. % to about 100 vol. % of hydrogen and carbon monoxide in the total amount of gaseous product. Suitably, about 65 vol. % to about 100 vol. % of hydrogen and carbon monoxide in the total amount of gaseous product, more suitably about 70 vol. % to about 100 vol. % of hydrogen and carbon monoxide, more suitably about 75 vol. % to about 100 vol. % of hydrogen and carbon monoxide, more suitably about 80 vol. % to about 100 vol. % of hydrogen and carbon monoxide, more suitably about 85 vol. % to about 100 vol. % of hydrogen and carbon monoxide, or more suitably about 90 vol. % to about 100 vol. % of hydrogen and carbon monoxide in the total amount of gaseous product.

In another embodiment, the gaseous product comprises about 60 vol. % to about 99 vol. % of hydrogen and carbon monoxide in the total amount of gaseous product. Suitably, about 65 vol. % to about 99 vol. % of hydrogen and carbon monoxide in the total amount of gaseous product, more suitably about 70 vol. % to about 99 vol. % of hydrogen and carbon monoxide, more suitably about 75 vol. % to about 99 vol. % of hydrogen and carbon monoxide, more suitably about 80 vol. % to about 99 vol. % of hydrogen and carbon monoxide, more suitably about 85 vol. % to about 99 vol. % of hydrogen and carbon monoxide, or more suitably about 90 vol. % to about 99 vol. % of hydrogen and carbon monoxide in the total amount of gaseous product.

In another embodiment, the gaseous product comprises about 60 vol. % to about 95 vol. % of hydrogen and carbon monoxide in the total amount of gaseous product. Suitably, about 65 vol. % to about 95 vol. % of hydrogen and carbon monoxide in the total amount of gaseous product, more suitably about 70 vol. % to about 95 vol. % of hydrogen and carbon monoxide, more suitably about 75 vol. % to about 95 vol. % of hydrogen and carbon monoxide, more suitably about 80 vol. % to about 95 vol. % of hydrogen and carbon monoxide, more suitably about 85 vol. % to about 95 vol. % of hydrogen and carbon monoxide, or more suitably about 90 vol. % to about 95 vol. % of hydrogen and carbon monoxide in the total amount of gaseous product.

In one embodiment, the gaseous product comprises about 5 vol. % or less of carbon dioxide. Suitably, about 4 vol. % or less of carbon dioxide in the gaseous product, more suitably about 3 vol. % or less of carbon dioxide, more suitably about 2 vol. % or less of carbon dioxide, more suitably about 1 vol. % or less of carbon dioxide, more suitably about 0.5 vol. % or less of carbon dioxide in the gaseous product.

In one embodiment, the gaseous product comprises about 0.1 vol. % to about 15 vol. % of carbon dioxide. Suitably, about 0.1 vol. % to about 12 vol. % of carbon dioxide in the gaseous product, more suitably about 0.1 vol. % to about 10 vol. % of carbon dioxide, more suitably about 0.1 vol. % to about 7 vol. % of carbon dioxide, more suitably about 0.1 vol. % to about 6 vol. % of carbon dioxide, more suitably about 0.1 vol. % to about 5 vol. % of carbon dioxide, more suitably about 0.1 vol. % to about 4 vol. % of carbon dioxide, more suitably about 0.1 vol. % to about 3 vol. % of carbon dioxide, more suitably about 0.1 vol. % to about 2 vol. % of carbon dioxide, more suitably about 0.1 vol. % to about 1 vol. % of carbon dioxide, more suitably about 0.1 vol. % to about 0.5 vol. % of carbon dioxide in the gaseous product.

In one embodiment, the gaseous product comprises about 5 vol. % or less of gaseous hydrocarbon. Suitably, about 4 vol. % or less of gaseous hydrocarbon in the gaseous product, more suitably about 3 vol. % or less of gaseous hydrocarbon, more suitably about 2 vol. % or less of gaseous hydrocarbon, more suitably about 1 vol. % or less of gaseous hydrocarbon, more suitably about 0.5 vol. % or less of gaseous hydrocarbon in the gaseous product.

In one embodiment, the gaseous product comprises about 0.1 vol. % to about 15 vol. % of gaseous hydrocarbon. Suitably, about 0.1 vol. % to about 12 vol. % of gaseous hydrocarbon in the gaseous product, more suitably about 0.1 vol. % to about 10 vol. % of gaseous hydrocarbon, more suitably about 0.1 vol. % to about 7 vol. % of gaseous hydrocarbon, more suitably about 0.1 vol. % to about 6 vol. % of gaseous hydrocarbon, more suitably about 0.1 vol. % to about 5 vol. % of gaseous hydrocarbon, more suitably about 0.1 vol. % to about 4 vol. % of gaseous hydrocarbon, more suitably about 0.1 vol. % to about 3 vol. % of gaseous hydrocarbon, more suitably about 0.1 vol. % to about 2 vol. % of gaseous hydrocarbon, more suitably about 0.1 vol. % to about 1 vol. % of gaseous hydrocarbon, more suitably about 0.1 vol. % to about 0.5 vol. % of gaseous hydrocarbon in the gaseous product.

In one embodiment the gaseous product is suitable for use as a fuel gas. In one embodiment, the gaseous product is syngas.

In one embodiment, the process is carried out in an atmosphere substantially free of oxygen. Suitably, an atmosphere free of oxygen. In another embodiment, process comprises exposing the gaseous hydrocarbon to microwave radiation in an atmosphere substantially free of oxygen, suitably free of oxygen.

In another embodiment, the process is carried out in an atmosphere substantially free of water. In another embodiment, process comprises exposing the gaseous hydrocarbon to microwave radiation in an atmosphere substantially free of water.

In another embodiment, the process is carried out in an atmosphere substantially free of oxygen and water. In another embodiment, process comprises exposing the gaseous hydrocarbon to microwave radiation in an atmosphere substantially free of oxygen and water.

In another embodiment, the process is carried out in an inert atmosphere. In another embodiment, process comprises exposing the gaseous composition to microwave radiation in an inert atmosphere.

The inert atmosphere may for instance be an inert gas or a mixture of inert gases. The inert gas or mixture of inert gases typically comprises a noble gas, for instance argon. In one embodiment the inert gas is argon. In another embodiment the inert gas is nitrogen.

The process may comprise purging the solid catalyst and/or reaction vessel with an inert gas or mixture of inert gases prior to exposing the gaseous hydrocarbon to the microwave radiation.

In one embodiment, the process is carried out in the presence of water. In one embodiment, the process is carried out in the presence of oxygen. In one embodiment, the process is carried out in the presence of air. In one embodiment, the process is carried out in the presence of water and oxygen.

In one embodiment the gaseous hydrocarbon is exposed to the solid catalyst prior to, during or both prior to and during exposure to the microwave radiation.

The gaseous hydrocarbon may be exposed to the catalyst by any suitable method. For instance, by continuously feeding the gaseous hydrocarbon over the catalyst, for instance by using a fixed or fluidized bed.

Any suitable space velocity may be employed for feeding the gaseous hydrocarbon over the catalyst. For instance, the gaseous hydrocarbon may be fed over the catalyst at a weight hour space velocity (WHSV) of equal to or greater than about 1 hr⁻¹. For instance, the gaseous hydrocarbon may be fed over the catalyst at a weight hour space velocity (WHSV) of equal to or greater than about 10 hr⁻¹. Suitably, the weight hour space velocity is equal to or greater than about 100 hr⁻¹, for instance equal to or greater than about 1000 hr⁻¹, or for example equal to or greater than about 2000 hr⁻¹.

In one embodiment WHSV is from about 100 hr⁻¹ to about 500,000 hr⁻¹. For example, a WHSV of from about 100 hr⁻¹ to about 400,000 hr⁻¹. For example, a WHSV of from about 100 hr⁻¹ to about 300,000 hr⁻¹. For example, a WHSV of from about 100 hr⁻¹ to about 200,000 hr⁻¹. For example, a WHSV of from about 100 hr⁻¹ to about 100,000 hr⁻¹. For example, a WHSV of from about 100 hr⁻¹ to about 50,000 hr⁻¹.

In one embodiment WHSV is from about 100 hr⁻¹ to about 500,000 hr⁻¹. In another embodiment WHSV is from about 1000 hr⁻¹ to about 500,000 hr⁻¹. For example, a WHSV of from about 1000 hr⁻¹ to about 400,000 hr⁻¹. For example, a WHSV of from about 1000 hr⁻¹ to about 300,000 hr⁻¹. For example, a WHSV of from about 1000 hr⁻¹ to about 200,000 hr⁻¹. For example, a WHSV of from about 1000 hr⁻¹ to about 100,000 hr⁻¹. For example, a WHSV of from about 1000 hr⁻¹ to about 50,000 hr⁻¹.

In the process of the invention, the gaseous hydrocarbon is exposed to microwave radiation in the presence of the catalyst in order to effect, or activate, the decomposition of said hydrocarbon to produce a gaseous product comprising hydrogen. Said decomposition may be catalytic decomposition. Exposing the gaseous hydrocarbon and catalyst to the microwave radiation may cause them to heat up. Other possible effects of the microwave radiation to which the gaseous hydrocarbon and catalyst are exposed (which may be electric or magnetic field effects) include, but are not limited to, field emission, plasma generation and work function modification. For instance, the high fields involved can modify catalyst work functions and can lead to the production of plasmas at the catalyst surface, further shifting the character of the chemical processes involved. Any one or more of such effects of the microwave radiation may be responsible for, or at least contribute to, effecting, or activating, the catalytic decomposition of the gaseous hydrocarbon to produce a gaseous product comprising hydrogen.

In principle, microwave radiation having any frequency in the microwave range, i.e. any frequency of from 300 MHz to 300 GHz, may be employed in the present invention. Typically, however, microwave radiation having a frequency of from 900 MHz to 4 GHz, or for instance from 900 MHz to 3 GHz, is employed.

In one embodiment, the microwave radiation has a frequency of from about 1 GHz to about 4 GHz. Suitably, the microwave radiation has a frequency of about 2 GHz to about 4 GHz, suitably about 2 GHz to about 3 GHz, suitably about 2.45 GHz.

The power which the microwave radiation needs to delivered to the composition, in order to effect the decomposition of the hydrocarbon to produce hydrogen, will vary, according to, for instance, the particular hydrocarbons employed, the particular catalyst employed in the reaction, and the size, permittivity, particle packing density, shape and morphology of the catalyst. The skilled person, however, is readily able to determine a level of power which is suitable for effecting the reaction.

The process of the invention may for example comprise exposing the gaseous hydrocarbon to microwave radiation which delivers a power per cubic centimetre of at least 1 Watt. It may however comprise exposing the gaseous hydrocarbon to microwave radiation which delivers a power per cubic centimetre of at least 5 Watts.

Often, for instance, the process comprises exposing the gaseous hydrocarbon to microwave radiation which delivers a power of at least 10 Watts, or for instance at least 20 Watts, per cubic centimetre. The process of the invention may for instance comprise exposing the gaseous hydrocarbon to microwave radiation which delivers at least 25 Watts per cubic centimetre.

Often, for instance, the process comprises exposing the gaseous hydrocarbon to microwave radiation which delivers a power of from about 0.1 Watt to about 5000 Watts per cubic centimetre. More typically, the process comprises exposing the gaseous hydrocarbon to microwave radiation which delivers a power of from about 0.5 Watts to 30 about 1000 Watts per cubic centimetre, or for instance a power of from about 1 Watt to about 500 Watts per cubic centimetre, such as, for instance, a power of from about 1.5 Watts to about 200 Watts, or say, from 2 Watts to 100 Watts, per cubic centimetre.

In some embodiments, the process comprises exposing the gaseous hydrocarbon to microwave radiation which delivers from about 5 Watts to about 100 Watts per cubic centimetre, or for instance from about 10 Watts to about 100 Watts per cubic centimetre, or for instance from about 20 Watts, or from about 25 Watts, to about 80 Watts per cubic centimetre.

Often, the power delivered to the gaseous hydrocarbon (or the “absorbed power”) is ramped up during the process of the invention. Thus, the process may comprise exposing the gaseous hydrocarbon to microwave radiation which delivers a first power to the composition, and then exposing the gaseous hydrocarbon to microwave radiation which delivers a second power to the gaseous hydrocarbon, wherein the second power is greater than the first. The first power may for instance be from about 2.5 Watts to about 6 Watts per cubic centimetre of the gaseous hydrocarbon. The second power may for instance be from about 25 Watts to about 60 Watts per cubic centimetre of the gaseous hydrocarbon.

The duration of exposure of the composition to the microwave radiation may also vary in the process of the invention. Embodiments are, for instance, envisaged wherein a given gaseous hydrocarbon is exposed to microwave radiation over a relatively long period of time, to effect sustained decomposition of the hydrocarbon on a continuous basis to produce a gaseous product comprising hydrogen over a sustained period.

Electromagnetic heating provides a method of fast, selective heating of dielectric and magnetic materials. Rapid and efficient heating using microwaves, for example, in which inhomogeneous field distributions in dielectric mixtures and field-focusing effects can lead to dramatically different product distributions. The fundamentally different mechanisms involved in microwave heating compared to traditional thermal processes may cause enhanced reactions and new reaction pathways. Furthermore, the high fields involved can modify catalyst work functions and can lead to the production of plasmas at the catalyst surface, further shifting the character of the chemical processes involved.

Accordingly, the gaseous hydrocarbon may need only to be exposed to the microwave radiation for a relatively short period of time. Typically, the exposure is for a duration of about 1 second to about 24 hours, for instance in a batch-wise process. Suitably, the process is for a duration of about 1 second to about 3 hours, more suitably for a duration of about 1 second to about 1 hour, more suitably for a duration of about 1 second to about 10 minutes, more suitably for a duration of about 1 second to about 5 minutes, more suitably for a duration of about 1 second to about 4 minutes, more suitably for a duration of about 1 second to about 3 minutes, more suitably for a duration of about 1 second to about 2 minutes, more suitably for a duration of about 1 second to about 1 minute.

In one embodiment, the process is for a duration of about 10 seconds to about 3 hours, for instance in a batch-wise process. Suitably, the process is for a duration of about 10 seconds to about 1 hour, more suitably for a duration of about 10 seconds to about 10 minutes, more suitably for a duration of about 10 seconds to about 5 minutes, more suitably for a duration of about 10 seconds to about 5 minutes, more suitably for a duration of about 10 seconds to about 4 minutes, more suitably for a duration of about 10 seconds to about 3 minutes, more suitably for a duration of about 10 seconds to about 2 minutes, more suitably for a duration of about 10 seconds to about 1 minute.

In another embodiment, the process is for a duration of about 30 seconds to about 3 hours, for instance in a batch-wise process. Suitably, the process is for a duration of about 30 seconds to about 1 hour, more suitably for a duration of about 30 seconds to about 10 minutes, more suitably for a duration of about 30 seconds to about 5 minutes, more suitably for a duration of about 30 seconds to about 4 minutes, more suitably for a duration of about 30 seconds to about 3 minutes, more suitably for a duration of about 30 seconds to about 2 minutes, more suitably for a duration of about 30 seconds to about 1 minute.

The process, and in particular the step of exposing the gaseous hydrocarbon to the microwave radiation, is typically carried out at ambient temperature and pressure.

In one embodiment, the process of the invention comprises heating of said gaseous hydrocarbon and/or solid catalyst by exposing it to microwave radiation.

In one embodiment of the process, one or more of the following apply:

a) The process is conducted in the presence of water;
b) The process is conducted without any gaseous input other than the gaseous hydrocarbon;
c) The process is conducted at ambient pressure; and
d) The process is conducted at ambient temperature.

In one embodiment (b)-(d) above apply. In another embodiment (b) and (c) above apply. In another embodiment (a)-(d) above apply.

In another embodiment, the process further comprises the step of treating the (spent) catalyst with a source of carbon dioxide (to regenerate the catalyst).

In one embodiment, the process of the invention comprises (i) exposing a gaseous hydrocarbon to microwave radiation in the presence of a solid catalyst, wherein the catalyst comprises at least one metal species on a support comprising a carbonate, wherein the metal species is at least one of a nickel species or a cobalt species, and (ii) treating the (spent) catalyst with a source of carbon dioxide (thereby regenerating the catalyst).

As used herein “spent catalyst” refers to the catalyst directly after employment in reforming of the gaseous hydrocarbon.

In one embodiment, the source of carbon dioxide is a gaseous source of CO₂ (CO₂(g)) (such as a flue gas, calcination gas, biogas, or air) or a carbonate, suitably an aqueous carbonate.

For example, the source of carbon dioxide in one embodiment is selected from CO₂(g), aqueous sodium carbonate and aqueous ammonium carbonate.

In one embodiment, the catalyst regenerated in (ii) is used as solid catalyst in (i) thereby providing a cycle of CO₂ capture and utilisation. In one embodiment, said cycle is repeated. In another embodiment, said cycle is performed up to about 100 times, or up to about 50 time, or up to about 30 times, or up to about 20 times, or up to about 15 times, or up to about 12 times.

In one embodiment, the process of the invention comprises (i) exposing a gaseous hydrocarbon to microwave radiation in the presence of a solid catalyst, wherein the catalyst comprises at least one metal species on a support comprising a carbonate, wherein the metal species is at least one of a nickel species or a cobalt species, and (ii) treating the spent catalyst with a source of carbon dioxide to provide a regenerated solid catalyst; and (iii) exposing a gaseous hydrocarbon to microwave radiation in the presence of the regenerated solid catalyst.

In one embodiment, steps (i) to (iii) are successively repeated. In one embodiment, (i) to (iii) are repeated between 1 and 20 times, suitably between 1 and 15 times, suitably between 1 and 12 times, suitably between 1 and 10 times, suitably between 1 and 8 times, suitably between 1 and 6 times, suitably between 1 and 4 times.

In one embodiment, the spent catalyst is calcined prior to treatment with a carbon dioxide source. In one embodiment, the spent catalyst is calcined in air at a temperature of 500° C. or greater, suitably 600° C. or greater, suitably about 700° C.

In one embodiment, the spent catalyst is calcined every 4 cycles, suitably every 6 cycles, or every 8 cycles, or every 10 cycles, or every 12 cycles.

In one embodiment, the process of the invention comprises (i) exposing a gaseous hydrocarbon to microwave radiation in the presence of a solid catalyst, wherein the catalyst comprises at least one metal species on a support comprising a carbonate, wherein the metal species is at least one of a nickel species or a cobalt species, and (ii) optionally calcining the spent catalyst, (iii) treating the optionally calcined spent catalyst with a source of carbon dioxide to provide a regenerated solid catalyst; and (iv) exposing a gaseous hydrocarbon to microwave radiation in the presence of the regenerated solid catalyst.

In one embodiment, the gaseous product is subjected to further treatment in provide further useful products. For instance, the skilled person would understand that the gaseous product could be subjected to water gas shift in order to increase the proportion of hydrogen in the gaseous product.

### Gaseous Hydrocarbon

The gaseous hydrocarbon is in the gaseous state at standard ambient temperature and pressure (SATP), i.e. at a temperature of 298.15 K (25° C.) and at 100,000 Pa (1 bar, 14.5 psi, 0.9869 atm). Said gaseous hydrocarbon will typically also be in the gaseous under the conditions (i.e. the temperature and pressure) at which the process is carried out.

In one embodiment, the composition comprises only one gaseous hydrocarbon. In another embodiment, the composition comprises a mixture of gaseous hydrocarbons.

In one embodiment, the gaseous hydrocarbon is substantially free of oxygenated species. In another embodiment, the gaseous hydrocarbon is free of oxygenated species.

In one embodiment, the gaseous hydrocarbon essentially comprises one or more C₁₋₄ hydrocarbons. In one embodiment, the gaseous hydrocarbon essentially consists of one or more C₁₋₄ hydrocarbons. In another embodiment, the gaseous hydrocarbon consists of one or more C₁₋₄ hydrocarbons. In another embodiment, the gaseous hydrocarbon consists of a single hydrocarbon selected from a C₁₋₄ hydrocarbon.

In another embodiment, the gaseous hydrocarbon is a single hydrocarbon selected from a C₁₋₄ hydrocarbon. Suitably, the gaseous hydrocarbon is selected from methane, ethane, propane, butane (for instance n-butane or iso-butane). Suitably, the gaseous hydrocarbon is selected from methane, ethane and propane. Suitably, the gaseous hydrocarbon is selected from methane and ethane.

Suitably, the gaseous hydrocarbon comprises methane. Suitably, the gaseous hydrocarbon essentially consists of methane. Suitably, the gaseous hydrocarbon consists of methane. Suitably, the gaseous hydrocarbon is methane.

In one embodiment, the gaseous hydrocarbon comprises about 70 vol. % or more of methane. Suitably, about 75 vol. % or more of methane, more suitably about 80 vol. % or more of methane, more suitably about 85 vol. % or more of methane, more suitably about 90 vol. % or more methane, more suitably about 95 vol. % or more of methane, more suitably about 98 vol. % or more of methane, more suitably about 99 vol. % or more of methane.

In another embodiment, the gaseous hydrocarbon comprises about 60 vol. % to about 100 vol. % of methane. Suitably, about 65 vol. % to about 100 vol. % of methane, more suitably about 70 vol. % to about 100 vol. % of methane, more suitably about 75 vol. % to about 100 vol. % of methane, more suitably about 80 vol. % to about 100 vol. % of methane, more suitably about 85 vol. % to about 100 vol. % of methane, or more suitably about 90 vol. % to about 100 vol. % of methane, more suitably about 100 vol. % of methane.

### Solid Catalyst

In another aspect of the invention there is provided a solid catalyst comprising at least one metal species on a support, wherein the at least one metal species is a nickel species or a cobalt species, and wherein the support comprises at least one of a carbonate or an alkaline earth metal oxide.

In one embodiment, the support comprises or essentially consists of, or consists of at least one carbonate.

In another embodiment, the support comprises or essentially consists of, or consists of at least one alkaline earth metal oxide.

The solid catalyst of the present invention is capable of absorbing microwaves. In one embodiment, the solid catalyst comprises at least one metal oxide on a support, wherein the metal oxide is at least one of a nickel oxide or a cobalt oxide, and wherein the support comprises at least one of a carbonate or an alkaline earth metal oxide.

In one embodiment, the solid catalyst comprises at least one metal oxide on a support comprising a carbonate, wherein the metal oxide is at least one of a nickel oxide or a cobalt oxide.

In one embodiment, the solid catalyst comprises at least one metal species on a support essentially consisting of a carbonate, wherein the metal species is at least one of a nickel species or a cobalt species.

In another embodiment, the solid catalyst comprises at least one metal species on a support consisting of a carbonate, wherein the at least one metal species is a nickel species or a cobalt species.

In one embodiment the metal species comprises a nickel species. In another embodiment, the metal species essentially consists of a nickel species. In another embodiment, the metal species consists of a nickel species. In another embodiment, the metal species is a nickel species.

In one embodiment, the nickel species is selected from elemental nickel, nickel oxides, nickel salts, nickel alloys, nickel hydroxides and nickel carbides. Suitably, the nickel species is selected from elemental nickel, a nickel alloy, a nickel oxide, a nickel carbide and a nickel hydroxide. Suitably, the nickel species is selected from elemental nickel, a nickel oxide, a nickel carbide and a nickel alloy. In one embodiment, the nickel species is a selected from elemental nickel, a nickel oxide and a mixture thereof. In one embodiment, the nickel species is a nickel oxide.

In one embodiment the metal species comprises elemental nickel, a nickel oxide or a mixture thereof. In another embodiment, the metal species essentially consists of elemental nickel, a nickel oxide or a mixture thereof. In another embodiment, the metal species consists of elemental nickel, a nickel oxide or a mixture thereof. In another embodiment, the metal species is elemental nickel, a nickel oxide or a mixture thereof.

In one embodiment the metal species comprises a cobalt species. In another embodiment, the metal species essentially consists of a cobalt species. In another embodiment, the metal species consists of a cobalt species. In another embodiment, the metal species is a cobalt species.

In one embodiment, the cobalt species is selected from elemental cobalt, cobalt oxides, cobalt salts, cobalt alloys, cobalt hydroxides and cobalt carbides. Suitably, the cobalt species is selected from elemental cobalt, cobalt oxides, cobalt carbides and cobalt alloys. In one embodiment, the cobalt species is a selected from elemental cobalt, an cobalt oxide and a mixture thereof.

In one embodiment the metal species comprises elemental cobalt, a cobalt oxide or a mixture thereof. In another embodiment, the metal species essentially consists of elemental cobalt, a cobalt oxide or a mixture thereof. In another embodiment, the metal species consists of elemental cobalt, a cobalt oxide or a mixture thereof. In another embodiment, the metal species is elemental cobalt, a cobalt oxide or a mixture thereof.

In another embodiment, the catalyst comprises at least two metal species. In one embodiment, the catalyst comprises one or two metal species.

In one embodiment, the catalyst comprises at least one nickel species and at least one further metal species, such as an elemental metal or metal oxide. Suitably the further metal species is a transition metal species.

In one embodiment the further metal species is selected from a cobalt, manganese, ruthenium, rhodium, palladium or platinum species. Suitably, the further metal species is selected from a cobalt or manganese species. Suitably the cobalt species is elemental cobalt, an oxide, or mixture thereof. Suitably the manganese species is elemental manganese, an oxide, or mixture thereof.

In one embodiment, the nickel species and the further metal species are present in a molar ratio of about 1:1 to about 1:50, suitably about 1:1 to about 1:30, suitably about 1:1 to about 1:25, suitably about 1:1 to about 1:20.

In another embodiment, the nickel species and the further metal species are present in a molar ratio of about 1:10 to about 1:50, suitably about 1:10 to about 1:30, suitably about 1:10 to about 1:25, suitably about 1:10 to about 1:20.

In another embodiment, the nickel species and the further metal species are present in a molar ratio of about 1:15 to about 1:50, suitably about 1:15 to about 1:30, suitably about 1:15 to about 1:25, suitably about 1:15 to about 1:20, suitably about 1:19.

Typically, the catalyst comprises particles of said metal species. The particles are usually nanoparticles.

Suitably, where said metal species comprises/essentially consists of/consists of metal(s) in elemental form said species is present as nanoparticles.

As used herein the term “nanoparticle” means a microscopic particle whose size is typically measured in nanometres (nm). A nanoparticle typically has a particle size of from 0.5 nm to 500 nm. For instance, a nanoparticle may have a particle size of from 0.5 nm to 200 nm. More often, a nanoparticle has a particle size of from 0.5 nm to 100 nm, or for instance from 1 nm to 50 nm. A particle, for instance a nanoparticle, may be spherical or non-spherical. Non-spherical particles may for instance be plate-shaped, needle-shaped or tubular.

The term “particle size” as used herein means the diameter of the particle if the particle is spherical or, if the particle is non-spherical, the volume-based particle size. The volume-based particle size is the diameter of the sphere that has the same volume as the nonspherical particle in question.

In one embodiment, the particle size of the metal species may be in the nanoscale. For instance, the particle size diameter of the metal species may be in the nanoscale.

As used herein, a particle size diameter in the nanoscale refers to populations of nanoparticles having d(0.5) values of 100 nm or less. For example, d(0.5) values of 90 nm or less. For example, d(0.5) values of 80 nm or less. For example, d(0.5) values of 70 nm or less. For example, d(0.5) values of 60 nm or less. For example, d(0.5) values of 50 nm or less. For example, d(0.5) values of 40 nm or less. For example, d(0.5) values of 30 nm or less. For example, d(0.5) values of 20 nm or less. For example, d(0.5) values of 10 nm or less.

As used herein, “d(0.5)” (which may also be written as “d(v, 0.5)” or volume median diameter) represents the particle size (diameter) for which the cumulative volume of all particles smaller than the d(0.5) value in a population is equal to 50% of the total volume of all particles within that population.

A particle size distribution as described herein (e.g. d(0.5)) can be determined by various conventional methods of analysis, such as Laser light scattering, laser diffraction, sedimentation methods, pulse methods, electrical zone sensing, sieve analysis and optical microscopy (usually combined with image analysis).

In one embodiment, a population of metal species of the catalyst have d(0.5) values of about 1 nm to about 100 nm. For example, d(0.5) values of about 1 nm to about 90 nm. For example, d(0.5) values of about 1 nm to about 80 nm. For example, d(0.5) values of about 1 nm to about 70 nm. For example, d(0.5) values of about 1 nm to about 60 nm. For example, d(0.5) values of about 1 nm to about 50 nm. For example, d(0.5) values of about 1 nm to about 40 nm. For example, d(0.5) values of about 1 nm to about 30 nm. For example, d(0.5) values of about 1 nm to about 20 nm. For example, d(0.5) values of about 1 nm to about 10 nm.

In another embodiment, a population of metal species of the catalyst have d(0.5) values of about 10 nm to about 100 nm. For example, d(0.5) values of about 10 nm to about 90 nm. For example, d(0.5) values of about 10 nm to about 80 nm. For example, d(0.5) values of about 10 nm to about 70 nm. For example, d(0.5) values of about 10 nm to about 60 nm. For example, d(0.5) values of about 10 nm to about 50 nm. For example, d(0.5) values of about 10 nm to about 40 nm. For example, d(0.5) values of about 10 nm to about 30 nm. For example, d(0.5) values of about 10 nm to about 20 nm. For example, d(0.5) values of about 10 nm.

In another embodiment, a population of metal species of the catalyst have d(0.5) values of about 20 nm to about 100 nm. For example, d(0.5) values of about 20 nm to about 90 nm. For example, d(0.5) values of about 20 nm to about 80 nm. For example, d(0.5) values of about 20 nm to about 70 nm. For example, d(0.5) values of about 20 nm to about 60 nm. For example, d(0.5) values of about 20 nm to about 50 nm. For example, d(0.5) values of about 20 nm to about 40 nm. For example, d(0.5) values of about 20 nm to about 30 nm. For example, d(0.5) values of about 20 nm.

In another embodiment, a population of metal species of the catalyst have d(0.5) values of about 30 nm to about 100 nm. For example, d(0.5) values of about 30 nm to about 90 nm. For example, d(0.5) values of about 30 nm to about 80 nm. For example, d(0.5) values of about 30 nm to about 70 nm. For example, d(0.5) values of about 30 nm to about 60 nm. For example, d(0.5) values of about 30 nm to about 50 nm. For example, d(0.5) values of about 30 nm to about 40 nm. For example, d(0.5) values of about 30 nm.

In another embodiment, a population of metal species of the catalyst have d(0.5) values of about 20 nm to about 100 nm. For example, d(0.5) values of about 40 nm to about 90 nm. For example, d(0.5) values of about 40 nm to about 80 nm. For example, d(0.5) values of about 40 nm to about 70 nm. For example, d(0.5) values of about 40 nm to about 60 nm. For example, d(0.5) values of about 40 nm to about 50 nm. For example, d(0.5) values of about 40 nm.

In another embodiment, a population of metal species of the catalyst have d(0.5) values of about 50 nm to about 100 nm. For example, d(0.5) values of about 50 nm to about 90 nm. For example, d(0.5) values of about 50 nm to about 80 nm. For example, d(0.5) values of about 50 nm to about 70 nm. For example, d(0.5) values of about 50 nm to about 60 nm. For example, d(0.5) values of about 50 nm.

The metal species of the solid catalyst described herein is loaded on a support comprising a carbonate or an alkaline earth metal oxide. Suitably, the support comprises a carbonate.

In one embodiment the support comprises one or more carbonates selected from an alkali metal carbonate or an alkaline earth metal carbonate.

In one embodiment, the support comprises one or more carbonates selected from Li, Na, K, Rb, Cs, Be, Mg, Ca, Sr, Ba, Cu and Zn carbonates.

In one embodiment, the support comprises one or more carbonates selected from Li, Na, K, Rb, Cs, Be, Mg, Ca, Sr and Ba carbonates. Suitably, the support comprises one or more carbonates selected from Mg, Sr, Ba and Ca carbonates.

In one embodiment, the support comprises calcium carbonate. In another embodiment, the support essentially consists of calcium carbonate. In another embodiment, the support consists of calcium carbonate. In another embodiment, the support is calcium carbonate.

In one embodiment, the support comprises an alkaline earth metal oxide. Suitably, the alkaline earth metal oxide is selected from one or more of calcium oxide (CaO), magnesium oxide (MgO), and barium oxide (BaO). Suitably, the alkaline earth metal oxide comprises calcium oxide (CaO). Suitably, the alkaline earth metal oxide is calcium oxide (CaO).

In one embodiment, the molar ratio of metal species to carbonate or alkaline earth metal oxide support in the solid catalyst is 1:100 or more, for example 1:50 or more, for example 1:24 or more, for example 1:20 or more, for example 1:18 or more, for example 1:12 or more, for example 1:9 or more.

In another embodiment, the molar ratio of metal species to carbonate or alkaline earth metal oxide support in the solid catalyst is about 1:20 to about 1:5. Suitably, the ratio of metal species to carbonate or alkaline earth metal oxide support in the solid catalyst is about 1:20 to about 1:9, for instance, about 1:20 to about 1:12. Suitably, the ratio of metal species to carbonate in the solid catalyst is about 1:18.

In another embodiment, the molar ratio of metal species to carbonate or alkaline earth metal oxide support in the solid catalyst is about 1:18 to about 1:5. Suitably, the ratio of metal species to carbonate in the solid catalyst is about 1:18 to about 1:9, for instance, about 1:18 to about 1:12.

In one embodiment, the catalyst has a molar ratio of metal species to carbonate support of between about 1:10 to about 1:20.

In one embodiment, the catalyst has a molar ratio of metal species to or alkaline earth metal oxide support of between about 1:10 to about 1:20.

In one embodiment, the solid catalyst comprises a nickel species which is elemental nickel, a nickel oxide, a nickel alloy, a nickel carbide or a mixture thereof; and an alkaline earth metal carbonate support. Suitably, alkaline earth metal carbonate is selected from calcium carbonate, magnesium carbonate, strontium carbonate and barium carbonate. More suitably, the carbonate is calcium carbonate.

In one embodiment, the solid catalyst comprises a nickel species which is elemental nickel, a nickel oxide or a mixture thereof; and an alkaline earth metal carbonate support. Suitably, alkaline earth metal carbonate is selected from calcium carbonate, magnesium carbonate, strontium carbonate and barium carbonate. More suitably the carbonate is calcium carbonate.

In one embodiment, the solid catalyst essentially consists of a nickel species which is elemental nickel, a nickel oxide, a nickel alloy, a nickel carbide or a mixture thereof; and an alkaline earth metal carbonate support. Suitably, alkaline earth metal carbonate is selected from calcium carbonate, magnesium carbonate, strontium carbonate and barium carbonate. More suitably the carbonate is calcium carbonate.

In one embodiment, the solid catalyst essentially consists of a nickel species which is elemental nickel, a nickel oxide or a mixture thereof; and an alkaline earth metal carbonate support. Suitably, alkaline earth metal carbonate is selected from calcium carbonate, magnesium carbonate, strontium carbonate and barium carbonate. More suitably the carbonate is calcium carbonate.

In one embodiment, the solid catalyst is elemental nickel and/or a nickel oxide supported on calcium carbonate. Suitably, the ratio of Ni to Ca in said catalysts is 1:24 or more, for example 1:20 or more, for example 1:18 or more, for example 1:12 or more, for example 1:9 or more.

In one embodiment, the solid catalyst is elemental nickel and/or a nickel oxide supported on calcium carbonate. Suitably, the ratio of Ni to Ca in said catalyst is about 1:20 to about 1:5. Suitably, about 1:20 to about 1:9, for instance, about 1:20 to about 1:12. Suitably, the ratio of nickel species to carbonate in the solid catalyst is about 1:18.

In one embodiment, the solid catalyst essentially consists of elemental nickel and/or a nickel oxide supported on calcium carbonate. Suitably, the ratio of Ni to Ca in said catalysts is 1:24 or more, for example 1:20 or more, for example 1:18 or more, for example 1:12 or more, for example 1:9 or more.

In one embodiment, the solid catalyst essentially consists of elemental nickel and/or a nickel oxide supported on calcium carbonate. Suitably, the ratio of Ni to Ca in said catalyst is about 1:20 to about 1:5. Suitably, about 1:20 to about 1:9, for instance, about 1:20 to about 1:12. Suitably, the ratio of nickel species to carbonate in the solid catalyst is about 1:18.

In one embodiment, the solid catalyst consists of a nickel oxide supported on calcium carbonate. Suitably, the ratio of Ni to Ca is about 1:18.

In one embodiment, the solid catalyst comprises a cobalt species which is elemental cobalt, a cobalt oxide, a cobalt alloy, a cobalt carbide or a mixture thereof; and an alkaline earth metal carbonate. Suitably, alkaline earth metal carbonate is selected from calcium carbonate, magnesium carbonate, strontium carbonate and barium carbonate. More suitable the carbonate is calcium carbonate.

In one embodiment, the solid catalyst comprises a cobalt species which is elemental cobalt, a cobalt oxide or a mixture thereof; and an alkaline earth metal carbonate. Suitably, alkaline earth metal carbonate is selected from calcium carbonate, magnesium carbonate, strontium carbonate and barium carbonate. More suitably the carbonate is calcium carbonate.

In one embodiment, the solid catalyst essentially consists of a cobalt species which is elemental cobalt, a cobalt oxide, a cobalt alloy, a cobalt carbide or a mixture thereof; and an alkaline earth metal carbonate. Suitably, alkaline earth metal carbonate is selected from calcium carbonate, magnesium carbonate, strontium carbonate and barium carbonate. More suitable the carbonate is calcium carbonate.

In one embodiment, the solid catalyst essentially consists of a cobalt species which is elemental cobalt, a cobalt oxide or a mixture thereof; and an alkaline earth metal carbonate. Suitably, alkaline earth metal carbonate is selected from calcium carbonate, magnesium carbonate, strontium carbonate and barium carbonate. More suitably the carbonate is calcium carbonate.

In one embodiment, the solid catalyst comprises elemental cobalt and/or a cobalt oxide supported on calcium carbonate. Suitably, the ratio of Co to Ca in said catalysts is 1:24 or more, for example 1:20 or more, for example 1:18 or more, for example 1:12 or more, for example 1:9 or more.

In one embodiment, the solid catalyst comprises elemental cobalt and/or a cobalt oxide supported on calcium carbonate. Suitably, the ratio of Co to Ca in said catalyst is about 1:20 to about 1:5. Suitably, about 1:20 to about 1:9, for instance, about 1:20 to about 1:12. Suitably, the ratio of cobalt species to carbonate in the solid catalyst is about 1:18.

In one embodiment, the solid catalyst essentially consists of elemental cobalt and/or a cobalt oxide supported on calcium carbonate. Suitably, the ratio of Co to Ca in said catalysts is 1:24 or more, for example 1:20 or more, for example 1:18 or more, for example 1:12 or more, for example 1:9 or more.

In one embodiment, the solid catalyst essentially consists of elemental cobalt and/or a cobalt oxide supported on calcium carbonate. Suitably, the ratio of Co to Ca in said catalyst is about 1:20 to about 1:5. Suitably, about 1:20 to about 1:9, for instance, about 1:20 to about 1:12. Suitably, the ratio of cobalt species to carbonate in the solid catalyst is about 1:18.

In one embodiment, the solid catalyst consists of a cobalt oxide supported on calcium carbonate. Suitably, the ratio of Co to Ca is about 1:18.

In one embodiment, the solid catalyst may comprise an additive and/or promotor. Examples of suitable additives and/or promotors include a cerium, titanium or zirconium species, such as elemental cerium, titanium or zirconium or an oxide thereof.

### Heterogeneous Mixture

In another aspect, the present invention provides a heterogeneous mixture, said mixture comprising a solid catalyst in admixture (suitably intimate admixture) with a gaseous hydrocarbon, wherein the catalyst comprises at least one metal species on a support comprising a carbonate, wherein the metal species is at least one of a nickel species or a cobalt species.

With respect to the solid catalyst, the gaseous hydrocarbon and the features of each, each of the above described embodiments are equally applicable to this aspect of the invention.

The present invention further relates to the use of the above described heterogeneous mixture to provide a gaseous product comprising hydrogen. This can be achieved by exposing the heterogeneous mixture to microwave radiation as described above.

### Microwave Reactor

In another aspect, the present invention relates to a microwave reactor comprising a heterogeneous mixture, said mixture comprising a solid catalyst in admixture (suitably intimate admixture) with a gaseous hydrocarbon, wherein the catalyst comprises at least one metal species on a support comprising a carbonate, wherein the metal species at least one of is a nickel species or a cobalt species.

With respect to the solid catalyst, gaseous hydrocarbon and the features thereof, each of the above described embodiments are equally applicable to this aspect of the invention.

Typically, the reactor is configured to receive the gaseous hydrocarbon and catalyst to be exposed to radiation. The reactor typically therefore comprises at least one vessel or inlet configured to comprise and/or convey the gaseous hydrocarbon in/to a reaction cavity, said cavity being the focus of the microwave radiation.

The reactor is also configured to export gaseous product. Thus, the reactor typically comprises an outlet through which gaseous product, generated in accordance with the process of the invention, may be released or collected.

In some embodiments, the microwave reactor is configured to subject the composition to electric fields in the TM010 mode.

### Fuel Cell Module

In a another aspect, the present invention provides a fuel cell module comprising a (i) a fuel cell and (ii) a heterogeneous mixture, said mixture comprising a solid catalyst in admixture (suitably intimate admixture) with a gaseous hydrocarbon, wherein the catalyst comprises at least one metal species on a support comprising a carbonate, wherein the metal species is at least one of a nickel species or a cobalt species.

Fuel cells, such as proton exchange membrane fuel cells, are well known in the art and thus readily available to the skilled person.

In one embodiment, the fuel cell module may further comprise (iii) a source of microwave radiation. Suitably, the source of microwave radiation is suitable for exposing the gaseous hydrocarbon and catalyst to microwave radiation and thereby effecting decomposition of the gaseous hydrocarbon or a component thereof to a gaseous product comprising hydrogen. Said decomposition may be catalytic decomposition.

Suitably, the source of the microwave radiation is a microwave reactor, suitably as described above.

The invention is now further described by means of the following numbered paragraphs:

1. A process for producing a gaseous product comprising hydrogen, said process comprising exposing a gaseous hydrocarbon to microwave radiation in the presence of a solid catalyst, wherein the catalyst comprises at least one metal species on a support, wherein the metal species is at least one of a nickel species or a cobalt species, and wherein the support comprises at least one of a carbonate or an alkaline earth metal oxide.
2. A process according to paragraph 1 wherein the gaseous product comprises about 40 vol. % or more of hydrogen, suitably about 70 vol. % or more of hydrogen, suitably about 80 vol. % or more, suitably about 90 vol. % of more of hydrogen.
3. A process according to paragraph 1 wherein the gaseous product comprises about 45 vol. % to about 75 vol. % of hydrogen, more suitably about 45 vol. % to about 70 vol. % of hydrogen, more suitably about 45 vol. % to about 65 vol. % of hydrogen, or more suitably about 45 vol. % to about 60 vol. % of hydrogen in the total amount of gaseous product.
4. A process according to paragraph 1 wherein the gaseous product further comprises carbon monoxide.
5. A process according to paragraph 1 wherein the gaseous product comprises about 70 vol. % or more of hydrogen and carbon monoxide in the total amount of gaseous product, suitably about 80 vol. % or more of hydrogen and carbon monoxide in the total amount of gaseous product, more suitably about 90 vol. % or more of hydrogen and carbon monoxide, more suitably about 99 vol. % or more of hydrogen and carbon monoxide in the total amount of gaseous product.
6. A process according to paragraph 1 wherein the gaseous product comprises about 60 vol. % to about 99 vol. % of hydrogen and carbon monoxide in the total amount of gaseous product, suitably, about 75 vol. % to about 99 vol. % of hydrogen and carbon monoxide in the total amount of gaseous product, more suitably about 80 vol. % to about 99 vol. % of hydrogen and carbon monoxide in the total amount of gaseous product.
7. A process according to any preceding paragraph wherein the gaseous product comprises about 5 vol. % or less of carbon dioxide.
8. A process according to any preceding paragraph wherein the gaseous product comprises hydrogen and carbon monoxide in a molar ratio of between about 1:1 to about 2:1 hydrogen to carbon monoxide.
9. A process according to paragraph 1 wherein the gaseous product is syngas.
10. A process according to any one of the preceding paragraphs wherein the metal species is a nickel species.
11. A process according to any one of the preceding paragraphs wherein the nickel species is selected from elemental nickel, a nickel alloy, a nickel oxide, a nickel carbide and a nickel hydroxide.
12. A process according to any one of the preceding paragraphs wherein the nickel species is selected from elemental nickel, a nickel oxide, and a mixture thereof.
13. A process according to any one of the preceding paragraphs wherein the nickel species is a nickel oxide.
14. A process according to any one of paragraphs 1 to 9 wherein the metal species is a cobalt species.
15. A process according to paragraph 14 wherein the cobalt species is selected from elemental cobalt, a cobalt alloy, a cobalt oxide, a cobalt carbide and a cobalt hydroxide.
16. A process according to paragraph 14 wherein the cobalt species is selected from elemental cobalt, a cobalt oxide, and a mixture thereof.
17. A process according to paragraph 14 wherein the cobalt species is a cobalt oxide.
18. A process according to any one of the preceding paragraphs wherein the catalyst comprises one or two metal species.
19. A process according to paragraph 18 wherein the catalyst comprises at least one nickel species and at least one further metal species, such as an elemental metal or metal oxide.
20. A process according to paragraph 19 wherein the further metal species is a transition metal species, suitably selected from a cobalt or manganese species.
21. A process according to any one of the preceding paragraphs wherein the support is a carbonate, suitably is an alkali metal carbonate or an alkaline earth metal carbonate.
22. A process according to any one of the preceding paragraphs wherein the support comprises one or more carbonates selected from Li, Na, K, Rb, Cs, Be, Mg, Ca, Sr and Ba carbonates, suitably, the support comprises one or more carbonates selected from Mg, Sr, Ba and Ca carbonates.
23. A process according to any one of the preceding paragraphs wherein the support is calcium carbonate.
24. A process according to any one of the preceding paragraphs wherein the molar ratio of metal species to carbonate or alkaline earth metal oxide support in the solid catalyst is 1:24 or more, for example 1:20 or more, for example 1:18 or more, for example 1:12 or more, for example 1:9 or more.
25. A process according to any preceding paragraph wherein the catalyst has a molar ratio of metal species to carbonate of between about 1:10 to about 1:20.
26. A process according to any preceding paragraph wherein the catalyst has a molar ratio of metal species to carbonate of about 1:18.
27. A process according to paragraphs 1 to 9 wherein the solid catalyst comprises a nickel species which is elemental nickel, a nickel oxide or a mixture thereof, and an alkaline earth metal carbonate, suitably selected from calcium carbonate, magnesium carbonate, strontium carbonate and barium carbonate.
28. A process according to paragraphs 1 to 9 wherein the solid catalyst comprises elemental nickel and/or a nickel oxide supported on calcium carbonate, suitably wherein the ratio of Ni to Ca in said catalyst is about 1:20 to about 1:5, suitably, about 1:20 to about 1:9, for instance, about 1:20 to about 1:12, suitably, the ratio of nickel species to carbonate in the solid catalyst is about 1:18.
29. A process according to any preceding paragraphs wherein the catalyst further comprises an additive and/or promotor, for example a cerium additive or promotor.
30. A process according to any one of the preceding paragraphs wherein the gaseous hydrocarbon is selected from one or more of methane, ethane, propane and butane.
31. A process according to any one of the preceding paragraphs wherein the gaseous hydrocarbon comprises methane.
32. A process according to any one of the preceding paragraphs wherein the gaseous hydrocarbon comprises 90 vol. % or more of methane, suitably about 95 vol. % or more.
33. A process according to any one of the preceding paragraphs wherein the gaseous hydrocarbon is fed over the catalyst at a weight hour space velocity (WHSV) of about 1000 hr⁻¹ to about 200,000 hr⁻¹.
34. A process according to any one of the preceding paragraphs wherein the exposure of to microwave radiation is for a duration of about 10 seconds to about 3 hours, suitably about 10 seconds to about 10 minutes, suitably about 10 seconds to about 5 minutes, more suitably for a duration of about 10 seconds to about 1 minute.
35. A process according to any one of the preceding paragraphs wherein one or more of (a) to (d) applies:
a) the process is conducted in the presence of water;
b) the process is conducted without any gaseous input other than the gaseous hydrocarbon;
c) the process is conducted at ambient pressure; and
d) the process is conducted at ambient temperature.
36. A process according to any preceding paragraph further comprising (ii) treating the spent catalyst with a source of carbon dioxide to provide a regenerated catalyst.
37. A process according to paragraph 36 wherein the source of carbon dioxide is gaseous carbon dioxide, sodium carbonate or ammonium carbonate.
38. A process according to paragraphs 36 and 27 wherein the regenerated catalyst is used as the solid catalyst in a process according to any one of paragraphs 1 to 35.
39. A process according to paragraph 38 wherein the process is repeated one or more times, suitably up to 100 times, or up to 50 time, or up to 30 times, or up to 20 time, or up to 15 times, or up to 12 times.
40. A process according to any one of paragraphs 36 to 39 wherein the spent catalyst is calcined prior to treatment with a carbon dioxide source.
41. A solid catalyst comprising one or more metal oxides on a support comprising a carbonate, wherein the metal oxide is selected from a nickel oxide or a cobalt oxide.
42. A solid catalyst according to paragraph 41 wherein the metal oxide comprises a nickel oxide, suitably the metal oxide is a nickel oxide.
43. A solid catalyst according to paragraph 42 wherein the carbonate is calcium carbonate.
44. A solid catalyst according to paragraph 43 wherein the catalyst has a molar ratio of nickel to calcium carbonate of between about 1:10 to about 1:20.
45. A solid catalyst according to paragraph 43 wherein the catalyst has a molar ratio of nickel to calcium carbonate of about 1:18.
46. A heterogeneous mixture, said mixture comprising a solid catalyst in admixture with a gaseous hydrocarbon, wherein the catalyst comprises at least one metal species on a support comprising a carbonate, wherein the metal species is at least one of a nickel species or a cobalt species
47. A heterogeneous mixture according to paragraph 46 wherein the solid catalyst is defined according to any one of paragraphs 41 to 45.
48. A microwave reactor comprising a heterogeneous mixture according to any one of paragraphs 46 to 47.
50. A fuel cell module comprising a (i) a fuel cell and (ii) a heterogeneous mixture according to any one of paragraphs 46 to 47.

### Examples

### Methods and Materials

### Catalyst Preparation

The required amount of carbonate powder was dispersed in 30 mL deionized water with a magnetic stirrer. Then, the corresponding amounts of metal nitrates were added into the carbonate suspension and keep stirring for 30 minutes. The water in the suspension was evaporated at 100° C. to form uniform slurry. Subsequently, the slurry was dried in 80° C. oven overnight and calcined at 500° C. for 1 hour. Finally, the obtained metal/carbonate solid (designated as MOₓ/carbonate, M represents the metal) was crushed into fine power for use.

In the preparations below, the total weight of CaCO₃ and metal oxides was fixed at 5 g, while the Ca to metal molar ratio was varied for each sample. CaCO₃ powder and all the metal nitrates were received from Sigma-Aldrich and Fisher, respectively. All the reagents have a purity higher than 99% and were used without further purification.

### Microwave-Initiated Hydrocarbon Reforming

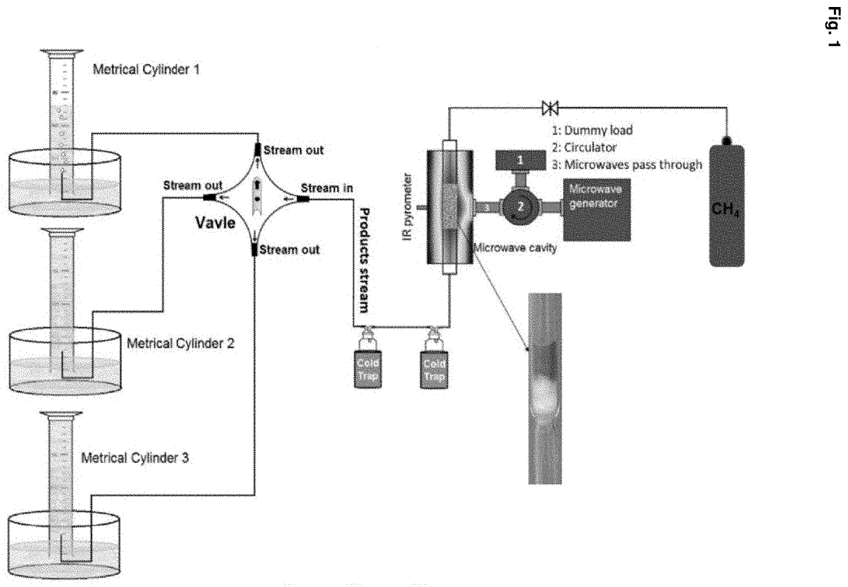

The microwave reforming was carried out on a setup which consists of a single mode microwave generation system, a purpose-built microwave cavity and control system. The experimental configuration is shown in FIG. 1. Prior to the microwave reaction, 0.5 g of the MOₓ/carbonate (for example NiO/CaCO₃) sample was loaded in an ID=8 mm quartz tube and then the tube was placed into the microwave cavity with the catalyst bed being located at the centre of the cavity. After the quartz tube reactor being installed, the flow system was purged with pure hydrocarbon (for example methane) at a flowrate of 150 mL/min for 15 mins and then the hydrocarbon flow was adjusted to the desired flowrate for the reforming reaction.

In each experiment, the outlet gas was collected immediately by the measuring cylinders (water pH was adjusted to 4 using diluted H₂SO₄ to eliminate CO₂ dissolution to ensure data accuracy) when the microwave was switched on. After the sample being irradiated for 150 seconds, the gas collection and microwave power were stopped at the same time. The volume of the collected gas was recorded, and the gas composition was determined by a gas chromatography (GC, PerkinElmer Clarus 580).

In this process, when the carbonate is CaCO₃ for example, it will decompose to form CaO and CO₂, and the released CO₂ will in-situ and rapidly be reformed with hydrocarbon (e.g. methane) to produce a gaseous product comprising hydrogen (for example, syngas). It is also noted that there is no need to activate the loaded metal on the MOₓ/carbonate samples, and thus is much simpler than that of the traditional thermal methane dry reforming process in which the loaded metal oxides need to be pre-reduced into the metallic state.

### CO₂ Capture (Catalyst Regeneration)

The residue of the metal/carbonate catalyst-absorbent system after hydrocarbon reforming was carbonated by 50 vol. % CO₂ with water as media to simulate the direct CO₂ capture from flue gases. Typically, 1 g of the spent catalyst was dispersed in 20 mL deionized water with 100 mL/min CO₂ flowing through the suspension for 3 hours. Then, the regenerated suspension was filtered and dried in 80° C. oven for the next cycle of the reforming reaction.

In a nickel/carbonate catalyst regeneration step, aqueous Na₂CO₃ and NH₄HCO₃ solution was also employed to carbonate the residue after reforming reaction. The basic principles of using Na₂CO₃ and NH₄HCO₃ as carbonate source to regenerate the reacted metal/calcium bi-functional catalyst system in H₂O medium are lying in reactions (1) to (3). The aqueous solution can then be used for carbon capture (reaction 4).

Na₂CO₃+H₂O+CaO=CaCO₃↓+2NaOH (Reaction 1)

2NaOH+CO₂=Na₂CO₃+H₂O (Reaction 2)

NH₄HCO₃+CaO=CaCO₃↓+NH₃—H₂O (Reaction 3)

NH₃.H₂O+CO₂═NH₄HCO₃ (Reaction 4)

### Data Analysis

Gas volume recorded by the measuring cylinder and the gas volume composition obtained by GC as well as the amounts of generated H₂, CO and the CO₂ residue. Subsequently the conversions of carbonate and the released CO₂ can be calculated. The reactions involved in a methane dry reforming process with CaCO₃ as CO₂ carrier are listed as follows:

CaCO₃→CaO+CO₂ (Reaction 5)

CO₂+CH₄→2CO+2H₂ (Reaction 6)

CH₄→C+2H₂ (Reaction 7)

(x-y)H₂+MOₓ→MO_{y}+(x-y)H₂O (Reaction 8)

H₂+CO₂→H₂O+CO (Reaction 9)

In all the MOₓ/CaCO₃ samples tested, the highest metal to calcium molar ratio is only 1:9, indicating that the portion of Reaction (8) contributing to the whole reforming process is very small. Moreover, the amount of water collected in the cold trap during the reaction period was negligible. Thus, the occurrence of Reactions (8) and (9) to the CaCO₃ decomposition and CO₂ conversions calculation was negligible. Thus, the conversions (X) of CaCO₃ decomposition and CO₂ reforming with CH₄ can be calculated as equations (1) and (2). In these equations, n represents the molar amounts of each component.

X_{CaCO3}═(n_{CO2}+½n_{CO})/n_{CO2 theoretical}×100% (equation 1)

X_{CO2}=½n_{CO}/(n_{CO2}+½n_{CO})×100% (equation 2)

CH₄ may be over cracked and carbon will deposit on the formed MO_{y}/CaO when CaCO₃ has already been deeply decomposed and no further CO₂ will be released before stopping microwave irradiation at t=150 s, then the H₂ to CO ratio would be greater than 1.0. Under this condition, the carbon deposition amount could be calculated as equation (3):

n_{C}=(n_{H2}−n_{CO})/2 (equation 3)

Mass Balance (MB) (%)=[(½n_{CO}+n_{CO2})×M_{CO}−½(n_{H2}−n_{CO})×M_{C}]/(m₀−mᵣ)×100% (equation 4)

Here, m₀ and mᵣ represent the total weight (including reactor, samples, quartz wool, et al.) before and after methane reforming reaction, respectively.

### Results and Discussion

### Methane Reforming Performances Over Different Metals Supported on CaCO₃

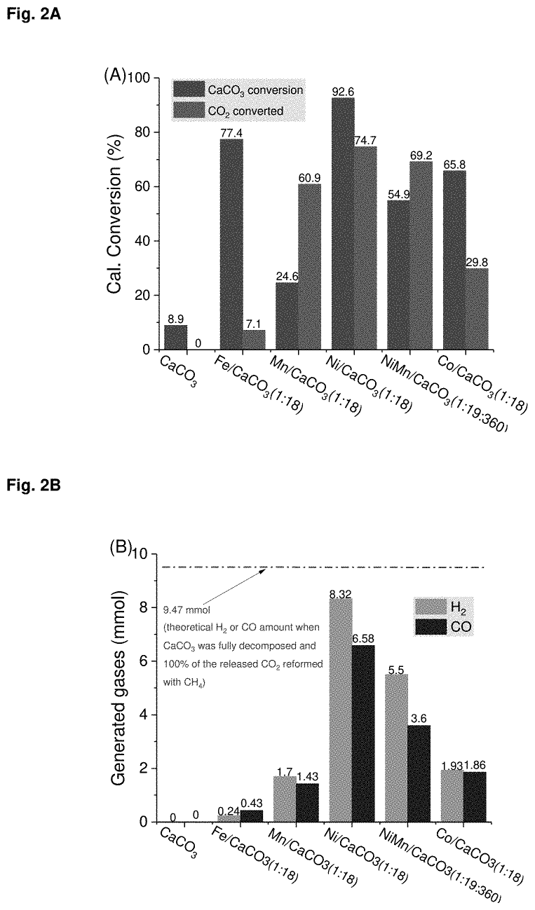

Catalyst samples with the oxides of Fe, Mn, Ni and Co supported on CaCO₃ powder were tested. For easier comparison, the metal to CaCO₃ molar ratios of the tested samples were fixed at 1:18. In all the methane reforming tests, the CH₄ flow and input microwave power were set at 100 mL/min and 750 W, respectively. The reforming results are shown in FIG. 2.

As seen in FIG. 2, the best methane reforming result was achieved over the cobalt oxide supported on CaCO₃ (NiO/CaCO₃). In the NiO/CaCO₃ bi-functional system, CaCO₃ nearly achieved a full decomposition with the conversion reached up to 92.6%, and the released CO₂ was also efficiently in-situ reformed with CH₄ into syngas at the same time (CO₂ conversion was 74.7%). The obtained H₂ and CO reached 8.32 and 6.58 mmol (if CaCO₃ fully decomposed and the released CO₂ could be 100% reformed with CH₄, both the obtained H₂ and CO amounts would be 9.5 mmol), respectively.

The performances of the metal/calcium bi-functional system were altered by supporting different metal oxides. All of the supported metal oxides enhanced CaCO₃ decomposition under microwave irradiation. However, the reforming of CH₄ with the released CO₂ differed. For example, though Fe oxide could facilitate CaCO₃ decomposition (77.4%), the catalytic reforming ability of Fe oxide was weak and only 7.1% of the released CO₂ was converted. It is apparent that the supported Mn, Co and Ni—Mn oxides also facilitated decomposition of CaCO₃ and activation of the released CO₂, however the generated H₂ and CO levels are lower than those obtained over NiO/CaCO₃.

Thus, among all these tested transition metals, cobalt is the best for enhancing CaCO₃ decomposition and reforming CO₂ with CH₄ simultaneously under microwave irradiation, although cobalt and Ni/Mn were able to reform methane to a hydrogen containing gas.

### Effect of the Ni/Ca Ratio on Reforming Performance

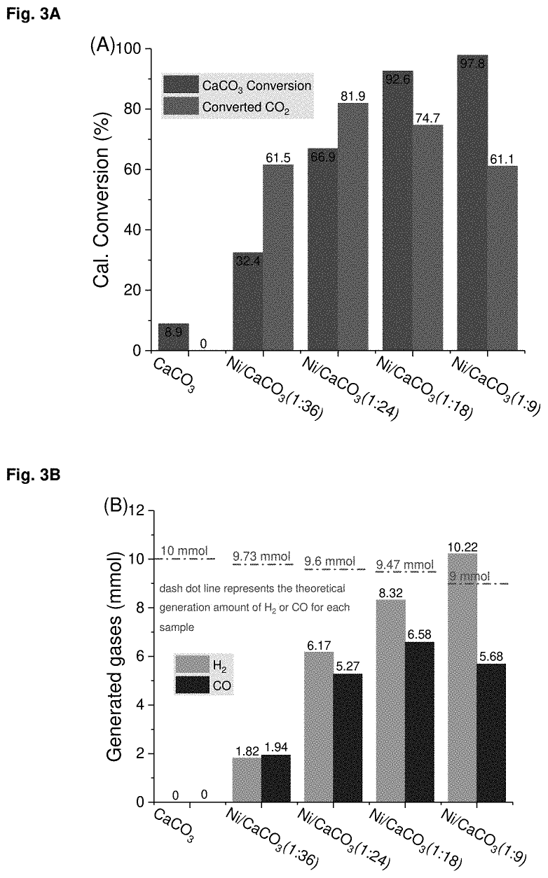

To find the optimum Ni/Ca ratio for the methane reforming reaction and subsequent CO₂ capture step, several CaCO₃ supported cobalt oxide samples were synthesized and their performances were evaluated under the same experimental conditions presented above (CH₄ flow rate 100 mL/min, microwave input power 750 W). The reforming results were shown in FIG. 3.

CaCO₃ decomposition could be significantly enhanced by increasing NiO loading amount (FIG. 3A), and the CaCO₃ conversion can be over 90% when Ni/Ca ratio is 1:18. A CaCO₃ conversion over a NiO/CaCO₃ sample with a 1:9 Ni/Ca ratio can reach 97.8%, which is slightly higher than that over the NiO/CaCO₃ (1:18) sample, however the methane reforming performance over the NiO/CaCO₃ sample with Ni/Ca ratio of 1:9 is not as good as that over the NiO/CaCO₃ sample with a Ni/Ca ratio of 1:18.

As seen in FIG. 3B, it is clear that the H₂/CO ratio in the gas product would be greater than 1 when the proportion of cobalt in the Ni/Ca ratio is higher than 1:24, which means that the methane cracking reaction (CH₄=C+2H₂) is more dominant than carbon gasification (C+CO₂=2CO) and consequently results in carbon deposition on the samples when Ni/Ca ratio is higher than a specific level. For the NiO/CaCO₃ sample with a Ni/Ca ratio of 1:9, the H₂/CO ratio in the gas product is 1.8, which is much higher than that over the NiO/CaCO₃ (1:18) sample (1.26), indicating carbon deposition on the catalyst when the Ni/Ca ratio is 1:9.

Carbon deposition would cover the cobalt particles and cause cobalt active site loss for the catalysts and consequently result in poor performance for methane reforming with CO₂. Thus, the cobalt oxide content loaded on the CaCO₃ powder is preferably controlled such that the cobalt/calcium bi-functional system could provide nearly equal abilities for methane cracking and carbon gasification.

Over the NiO/CaCO₃ sample with a Ni/Ca ratio of 1:18, CaCO₃ can be extensively decomposed (92.6% conversion) to CaO, and this extensive CaCO₃ decomposition will provide high CO₂ uptake capacity for the sample in the subsequent CO₂ capture step. Moreover, 74.7% of the released CO₂ (the highest among the tested samples) can reform efficiently with CH₄ into syngas, achieving a comprehensive and excellent performance. Thus, taking both CaCO₃ decomposition and methane reforming with the released CO₂ into consideration, the preferred Ni/Ca ratio for the NiO/CaCO₃ bi-functional system is 1:18 among these tested samples.

Reforming Results with Different CH₄ Flowrates

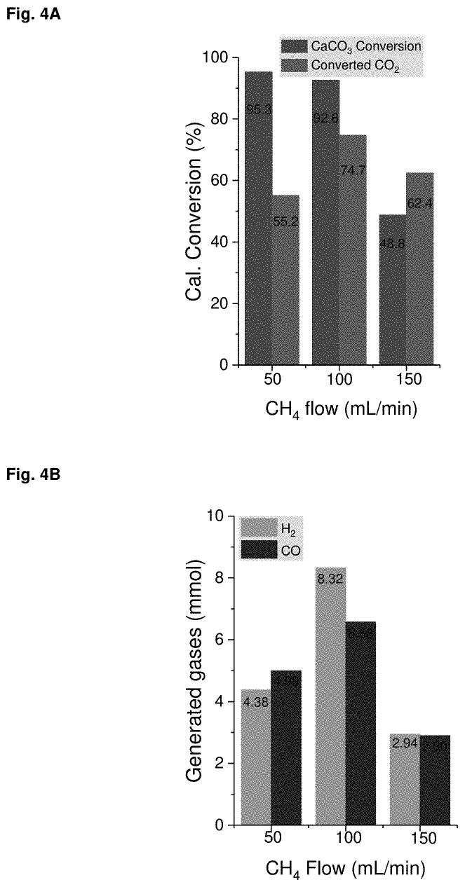

The effect of CH₄ flowrate was studied and the reforming results with CH₄ feed flowrate being fixed at 50, 100 and 150 mL/min (FIG. 4).

As seen in FIG. 4, the preferred CH₄ feed flowrate is 100 mL/min under the operating conditions. A suitable CH₄ feed flowrate should provide enough CH₄ to reform with the in-situ released CO₂ from CaCO₃ decomposition without taking CO₂ and heat out of the reactor before the completion of reforming reaction.

Representative “Time-On-Stream” Experiment Over the NiO/CaCO₃ Sample with a Ni/Ca Ratio of 1:18

The “time-on-stream” experiment was also conducted using the setup as illustrated in FIG. 1.

Prior to the microwave reaction, 0.5 g of the MOₓ/CaCO₃ (for example NiO/CaCO₃) sample is loaded in an ID=8 mm quartz tube and then the tube placed into the microwave cavity with the catalyst bed being located at the center of the cavity. After the quartz tube reactor being correctly connected, the flow system is purged with pure methane at a flowrate of 150 mL/min for 15 mins. Then, the methane flowrate is adjusted to 100 mL/min, and the system is ready for microwave irradiation. The outlet gas is collected immediately after the microwave power is switched on, and the gas sample is collected for each 30 seconds and analysed by GC. In the other words, in the period of 0˜30 seconds, the gas is collected, stored and measured in metrical cylinder 1# and then analysed by GC. At the moment of t=30 seconds, the outstream valve is immediately switched to metrical cylinder 2#, and the gas sample in period of 31˜60 seconds would is collected in this cylinder. Similarly, the outlet gas in the periods of 61˜90, 91˜120 and 121˜150 seconds will be also collected and measured in separate cylinders and then analysed by GC. (NB. the water pH is adjusted to 4 using diluted H₂SO₄ to eliminate CO₂ dissolution to ensure data accuracy).

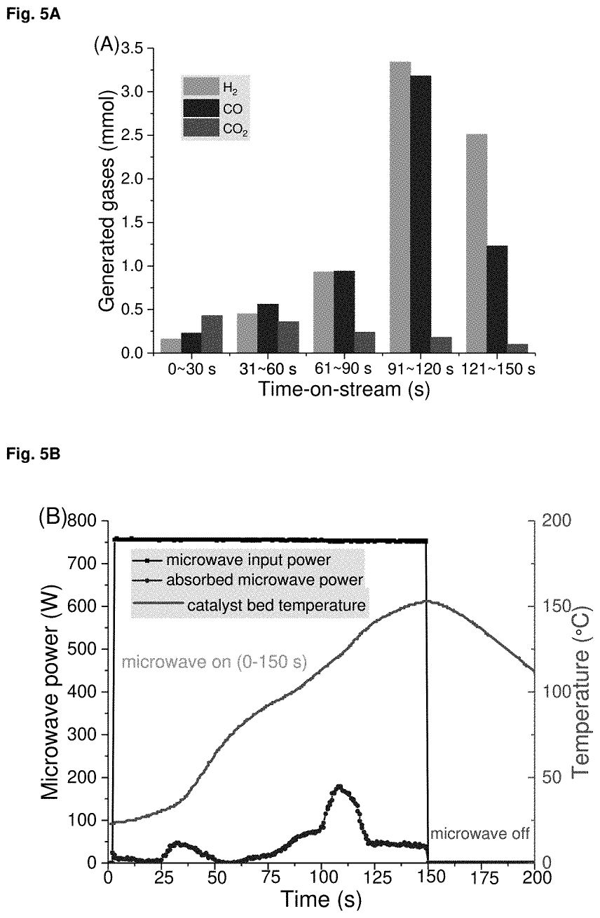

As illustrated in FIG. 5, the methane reforming process can be extremely fast (within 150 seconds) under microwave irradiation, CaCO₃ decomposition and methane reforming with the released CO₂ mainly occurred in the period of 60 to 150 seconds, and the absorbed microwave power was also increased in this period. In the period of 121 to 150 seconds, we can see that the H₂/CO ratio is higher than 1, indicating that methane cracking is much stronger than carbon gasification, which can be attributed to the fact that CaCO₃ is nearly completely decomposed and no further CO₂ can be released for carbon gasification and as a consequence more H₂ than CO is generated in this period.

It is also noted that the measured catalyst temperature during the whole reforming process is below 200° C., indicating that the reforming reaction can be completed without generating much heat. This helps to increase the energy efficiency of the methane reforming and CO₂ capture process.

Cyclic Methane Reforming Over the Cobalt/Carbonate Catalysts Regenerated with CO₂

The used catalysts after methane reforming reaction were collected and regenerated using CO₂ in the H₂O medium as previously described. This CO₂ regeneration step simulates the CO₂ capture from flue gases in industry and sucking CO₂ from atmosphere using CaO based absorbents.

As evident from the results presented above, the methane reforming reaction can be directly initiated by cobalt oxide supported on CaCO₃ with microwave irradiation, so there is no need to pre-reduce the samples using H₂. Thus, this microwave-assisted methane reforming over a NiO/CaCO₃ sample is much easier than the traditional thermal processes starting from CaO for CO₂ capture (carried out below 650° C.) and conversion (normally above 750° C.), in which the supported metals need to be pre-reduced using H₂. Thus, the present process can be directly started from cobalt oxide/CaCO₃ composite and avoids using large amounts of calcium salts such as calcium nitrate and calcium acetate to prepare CaO absorbent, consequently, reducing pollutant emissions (nitrogen oxides or CO₂) and making the sample preparation process much easier, cheaper and greener.

It is also noteworthy that the oxide state cobalt can efficiently start the methane reforming process with the help of microwaves, this indicates that there is no need to care about the initial state of cobalt, whether in oxide or metallic states. Which is beneficial in real-world scenarios, for example the direct CO₂ capture from atmosphere and flue gas in which water and oxygen will be encountered.

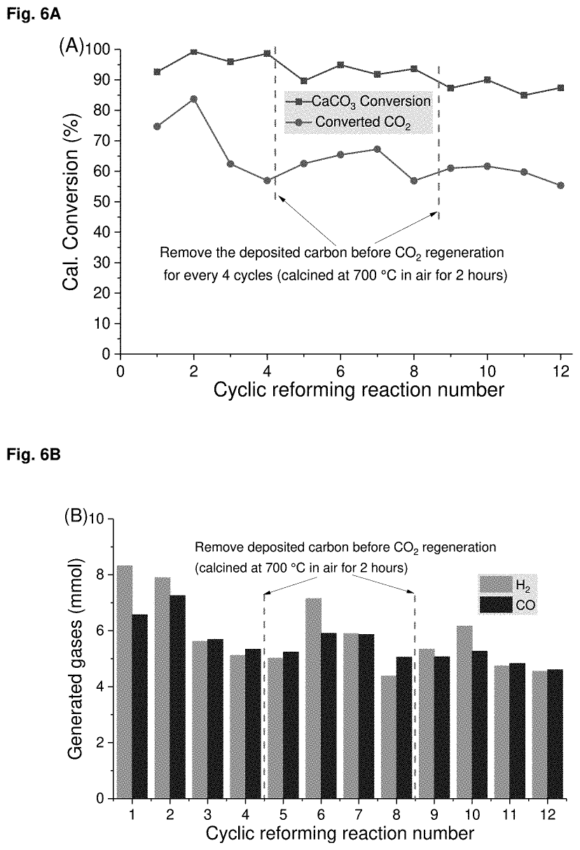

A cyclic methane reforming and CO₂ capture experiment over a catalyst with a Ni/Ca ratio of 1:18 was carried out and the results are illustrated in FIG. 6.

In this experiment, for every four cycles, the used catalyst after methane reforming reaction is calcined in air at 700° C. for 2 hours to remove the deposited carbon and then regenerated by CO₂ treatment for the next cycle of methane reforming. In the methane reforming, CaCO₃ conversion can be maintained higher than 90% in 12 cycles and more than 55% of the released CO₂ can be in-situ reformed with CH₄ into syngas, demonstrating the adequate stability of the cobalt/carbonate system for cyclic methane reforming and CO₂ capture.

### Cyclic Reforming Over Catalysts Regenerated by Different Carbonate Sources

For catalyst regeneration using Na₂CO₃ and NH₄HCO₃, 1 g of the used sample (Ni/Ca ratio of 1:18) after methane reforming reaction was dispersed in 30 mL solution (containing 20 mmol Na₂CO₃ and 40 mmol NH₄HCO₃, respectively) and stirred for 3 hours. A sample regenerated by Na₂CO₃ was filtered and was rinsed for 3 times to remove Na⁺ ions. Both the samples regenerated by Na₂CO₃ and NH₄HCO₃ were dried at 80° C. for overnight.

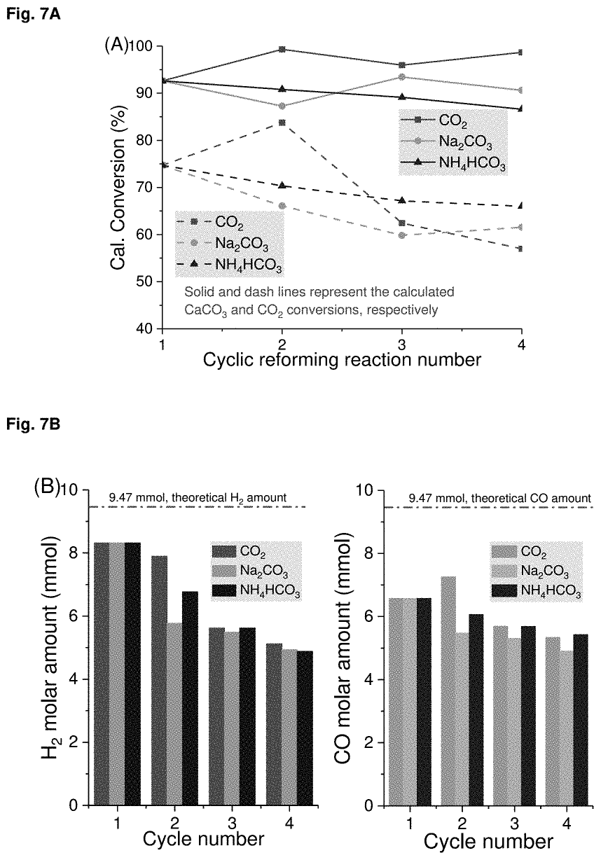

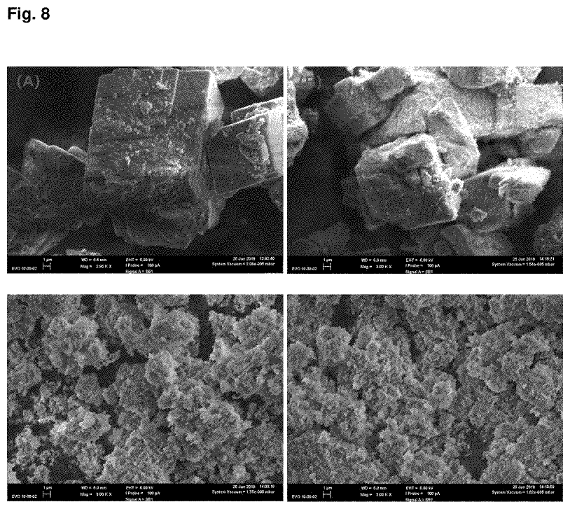

Cyclic methane reforming performance of the samples regenerated by CO₂ (g), Na₂CO₃ and NH₄HCO₃ were tested under the same conditions (100 mL/min CH₄ flow, 750 W microwave input power, 0.5 g of regenerated sample in each test), and the results are shown in FIG. 7.

As seen in FIG. 7, the microwave-initiated cyclic methane reforming performances of the samples regenerated by CO₂ (g), Na₂CO₃ and NH₄HCO₃ are very similar and can be maintained at high levels for at least four successive cycles. In each cycle, CaCO₃ nearly completely decomposed and the calculated conversions are higher than 90%. Though the CO₂ conversion showed a trend of decrease which could be attributed to the carbon deposition on cobalt sites. Nevertheless, CO₂ conversion was maintained at a level higher than 55%.

The proposed bi-functional cobalt/carbonate catalyst is amenable to different regeneration strategies using CO₂ (g), Na₂CO₃ or NH₄HCO₃ as CO₂ sources, and these varied CO₂ sources can help the cobalt/carbonate system to be suitable for different CO₂ capture scenarios which would be encountered in industry.

### Sample Morphology Changes

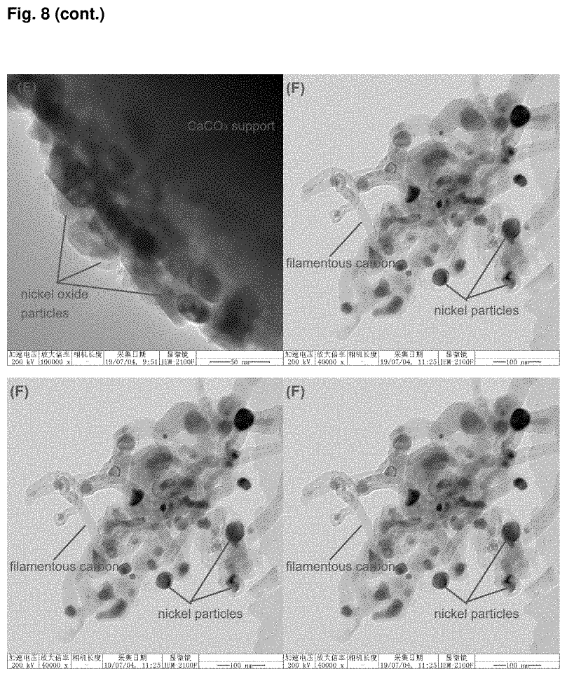

The morphology changes of the cobalt/carbonate catalyst with a Ni/Ca ratio of 1:18 evident from the catalyst before and after methane reforming reaction, and after CO₂ regeneration are presented in FIG. 8.

As seen in FIGS. 8A and B, the cobalt/carbonate system has the appearance of cubic particles, and the surfaces of the particles are covered with hairy carbon after the methane reforming reaction. As confirmed by the TEM images shown in FIGS. 8E and F, cobalt oxide nano-particles were dispersed on the surface of CaCO₃ cubic support and the cobalt nano-particles will be encapsulated by the deposited filamentous carbon, this is consistent with the small decrease of methane reforming performance in the cyclic experiment to carbon deposition on cobalt sites.

After CO₂ regeneration in H₂O medium, the cubic calcium particles disintegrated into platelets with much smaller sizes and these platelets aggregated in a flower-like appearance (FIG. 8C). The TEM image (FIG. 8G) indicates improved cobalt particle dispersion benefits the microwave-initiated methane reforming.

In FIGS. 8D and 8H, it is clear that the cobalt/carbonate catalyst after 12 cycles of CO₂ capture and methane reforming are still in small platelets, and cobalt nano-particles were well dispersed. At this stage, the CaO absorbent (also as support for cobalt particles) possesses porous nano structures which could help improve CO₂ capture. All these morphology results indicate that the sample structure changes would not cause adverse effect on the cyclic CO₂ capture and methane reforming performance of this cobalt/carbonate bi-functional system.

### Summary

The metal oxide/carbonate catalysts can be used as a catalyst to effectively and directly reform methane into a gaseous product comprising hydrogen under microwave irradiation.

The carbonate acts as CO₂ carrier and adsorbent precursor. Under microwave irradiation, the supported metal species can enhance carbonate decomposition and in-situ catalyzes the released CO₂ to reform gaseous hydrocarbon into a gaseous product comprising hydrogen. The adsorbent formed on carbonate decomposition (for example CaO when the carbonate is CaCO₃) acts as absorbent for the subsequent CO₂ capture. Thus, realizing a cyclic in-situ methane reforming and CO₂ capture process.

Various transition metal (oxide) systems are effective with cobalt preferable (cobalt is effective in both oxide and metallic states). There is no need to pre-reduce the catalyst using H₂, and the methane reforming could be directly initiated even with the supported metal in oxide state.

Cyclic CO₂ capture and methane reforming using a NiOₓ/CaCO₃ system, extensively decomposed the carbonate (typically around 90%) and ≥55% CO₂ generated was reformed with CH₄ in one step.

Various CO₂ sources (CO₂(g), Na₂CO₃ and NH₄HCO₃ can be used to regenerate the catalyst and the regenerated catalysts show similar methane reforming performance to fresh samples.

### REFERENCES

1. Tian, S., Yan, F., Zhang, Z., & Jiang, J. (2019). Calcium-looping reforming of methane realizes in situ CO₂ utilization with improved energy efficiency. Science advances, 5(4), eaav5077.
2. Jie, X., Gonzalez-Cortes, S., Xiao, T., Yao, B., Wang, J., Slocombe, D. R., Edwards, P. P. & Thomas, J. M. (2019). The decarbonisation of petroleum and other fossil hydrocarbon fuels for the facile production and safe storage of hydrogen. Energy & Environmental Science, 12(1), 238-249.
3. Pakhare, D., & Spivey, J. (2014). A review of dry (CO₂) reforming of methane over noble metal catalysts. Chemical Society Reviews, 43(22), 7813-7837.
4. Sun, H., Wang, J., Zhao, J., Shen, B., Shi, J., Huang, J., & Wu, C. (2019). Dual functional catalytic materials of Ni over Ce-modified CaO sorbents for integrated CO₂ capture and conversion. Applied Catalysis B: Environmental, 244, 63-75.
5. Blamey, J., Anthony, E. J., Wang, J., & Fennell, P. S. (2010). The calcium looping cycle for large-scale CO₂ capture. Progress in Energy and Combustion Science, 36(2), 260-279.
6. Zhang, X., Lee, C. S. M., Mingos, D. M. P., & Hayward, D. O. (2003). Carbon dioxide reforming of methane with Pt catalysts using microwave dielectric heating. Catalysis letters, 88(3-4), 129-139.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise paragraphed. No language in the specification should be construed as indicating any non-paragraphed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the paragraphs appended hereto as permitted by applicable law.

1. A process for producing a gaseous product comprising hydrogen, said process comprising exposing a gaseous hydrocarbon to microwave radiation in the presence of a solid catalyst, wherein the catalyst comprises at least one metal species on a support, wherein the metal species is at least one of a nickel species or a cobalt species, and wherein the support comprises at least one of a carbonate or an alkaline earth metal oxide.

2. A process according to claim 1 wherein the gaseous product further comprises carbon monoxide.

3. A process according to claim 1 wherein the gaseous product comprises about 90 vol. % or more of hydrogen and carbon monoxide in the total amount of gaseous product.

4. A process according to claim 1 wherein the gaseous product comprises hydrogen and carbon monoxide in a molar ratio of between about 1:1 to about 2:1 hydrogen to carbon monoxide.

5. A process according to claim 1 wherein the metal species is a nickel species.

6. A process according to claim 1 wherein the nickel species is selected from elemental nickel, a nickel oxide, and a mixture thereof.

7. A process according to claim 1 wherein support comprises a carbonate.

8. A process according to claim 1 wherein the carbonate is an alkali metal carbonate or an alkaline earth metal carbonate.

9. A process according to claim 1 wherein the support is calcium carbonate.

10. A process according to claim 1 wherein the catalyst has a molar ratio of metal species to carbonate or alkaline earth metal oxide support of between about 1:10 to about 1:20.

11. A process according to claim 1 wherein the catalyst has a molar ratio of metal species to carbonate or alkaline earth metal oxide support of about 1:18.

12. A process according to claim 1 wherein the solid catalyst consists of elemental nickel and/or a nickel oxide supported on calcium carbonate.

13. A process according to claim 1 wherein the alkaline earth metal oxide is calcium oxide.

14. A process according to claim 1 wherein the gaseous hydrocarbon is selected from one or more of methane, ethane, propane and butane.

15. A process according to claim 1 wherein the gaseous hydrocarbon comprises at least about 90 vol. % of methane.

16. A process according to claim 1 further comprising treating the spent catalyst with a source of carbon dioxide.

17. A process according to claim 16 wherein the source of carbon dioxide is a source of gaseous carbon dioxide, sodium carbonate or ammonium carbonate.

18. A process according to claim 16 wherein the catalyst after treatment with a source of carbon dioxide is used as the solid catalyst.

19. A process according to claim 16 wherein the spent catalyst is calcined prior to treatment with a carbon dioxide source.

20. A solid catalyst comprising one or more metal oxides on a support comprising a carbonate, wherein the metal oxide is at least one of a nickel oxide or a cobalt oxide.

21. A solid catalyst according to claim 20 wherein the metal oxide comprises a nickel oxide.

22. A solid catalyst according to claim 21 wherein the carbonate is calcium carbonate.

23. A solid catalyst according to claim 20 wherein the catalyst has a molar ratio of nickel to calcium carbonate of about 1:18.

24. A microwave reactor comprising a heterogeneous mixture, said mixture comprising a solid catalyst in admixture with a gaseous hydrocarbon, wherein the catalyst comprises at least one metal species on a support comprising a carbonate, wherein the metal species is at least one of a nickel species or a cobalt species.
